(19) United States
(12) Patent Application Publication
(10) Pub. No.: US 2015/0070545 A1
(43) Pub. Date: Mar. 12, 2015

(54) SOLID-STATE IMAGING DEVICE

(71) Applicant: KABUSHIKI KAISHA TOSHIBA, Minato-ku (JP)

(72) Inventors: Shinichi OHSAWA, Machida-shi (JP); Junichi Hosokawa, Yokohama-shi (JP)

(73) Assignee: KABUSHIKI KAISHA TOSHIBA, Minato-ku (JP)

(21) Appl. No.: 14/200,962

(22) Filed: Mar. 7, 2014

(30) Foreign Application Priority Data
Sep. 12, 2013 (JP) 2013-189816

(51) Int. Cl. H04N 5/359

(52) U.S. Cl. CPC H04N 5/359
USPC 348/299

(57) ABSTRACT

According to one embodiment, a solid-state imaging device includes an image sensor including a valid pixel area having valid pixels and a light-blocking pixel area having light-blocking pixels to generate an image signal; and a clamp circuit that detects an overflow of a signal charge and executes a black level signal processing for the image signal using a parameter. The clamp circuit detects the overflow using an integration value of the signals of the light-blocking pixels integrated in a direction from the light-blocking pixel area to the valid area, and sets the parameter generated from the output signals of the light-blocking pixels substantially not influenced by the overflow based on a result of the detection.

### CROSS-REFERENCE TO RELATED APPLICATIONS

This application is based upon and claims the benefit of priority from Japanese Patent Application No. 2013-189816, filed Sep. 12, 2013, the entire contents of which are incorporated herein by reference.

### FIELD

Embodiments described herein relate generally to a solid-state imaging device.

### BACKGROUND

A solid-state imaging device such as a charge-coupled device (CCD) image sensor or a complementary metal oxide semiconductor (CMOS) image sensor is employed in various applications such as a digital camera, a video camera, or a monitoring camera.

It is demanded to improve an image quality of the solid-state imaging device.

### BRIEF DESCRIPTION OF THE DRAWINGS

FIG. 1 is a block diagram illustrating an exemplary configuration of a solid-state imaging device;

FIG. 2 is an equivalent circuit diagram illustrating an exemplary internal configuration of the solid-state imaging device;

FIG. 3 is a block diagram illustrating an exemplary internal configuration of the solid-state imaging device;

FIG. 4 is a block diagram illustrating an exemplary internal configuration of a solid-state imaging device according to a first embodiment;

FIG. 5 is a schematic diagram illustrating an exemplary operation of a solid-state imaging device according to a first embodiment;

FIG. 6 is a block diagram illustrating an exemplary internal configuration of a solid-state imaging device according to a second embodiment;

FIG. 7 is a schematic diagram illustrating an exemplary operation of a solid-state imaging device according to a second embodiment;

FIG. 8 is a block diagram illustrating an exemplary internal configuration of a solid-state imaging device according to a third embodiment;

FIG. 9 is a schematic diagram illustrating an exemplary operation of a solid-state imaging device according to a third embodiment;

FIG. 10 is a block diagram illustrating an exemplary internal configuration of a solid-state imaging device according to a fourth embodiment;

FIG. 11 is a schematic diagram illustrating an exemplary operation of a solid-state imaging device according to a fourth embodiment;

FIGS. 12 and 13 are block diagrams illustrating a modification of the solid-state imaging device according to an embodiment of the invention; and

FIG. 14 is a block diagram illustrating an application example of the solid-state imaging device according to an embodiment of the invention.

### DETAILED DESCRIPTION

### Embodiments

Hereinafter, embodiments of the invention will be described in detail with reference to the accompanying drawings. In the following description, like reference numerals denote like elements, and the description thereof will only be repeated if necessary.

In general, according to one embodiment, a solid state imaging device includes an image sensor including a valid pixel area having a plurality of valid pixels and a light-blocking pixel area having a plurality of light-blocking pixels to generate an image signal from output signals of the valid pixels and the light-blocking pixels; and at least one clamp circuit that detects an overflow of signal charge from the valid pixel area to the light-blocking pixel area and that executes a black level signal processing for the image signal using a parameter generated from signals of the light-blocking pixels. The clamp circuit detects the overflow of the signal charge using an integration value of the signals of the light-blocking pixels integrated in a direction from the light-blocking pixel area to the valid area, and sets the parameter generated from the output signals of the light-blocking pixels substantially not influenced by the overflow of the signal charge based on a result of the detection of the overflow of the signal charge.

### (1) First Embodiment

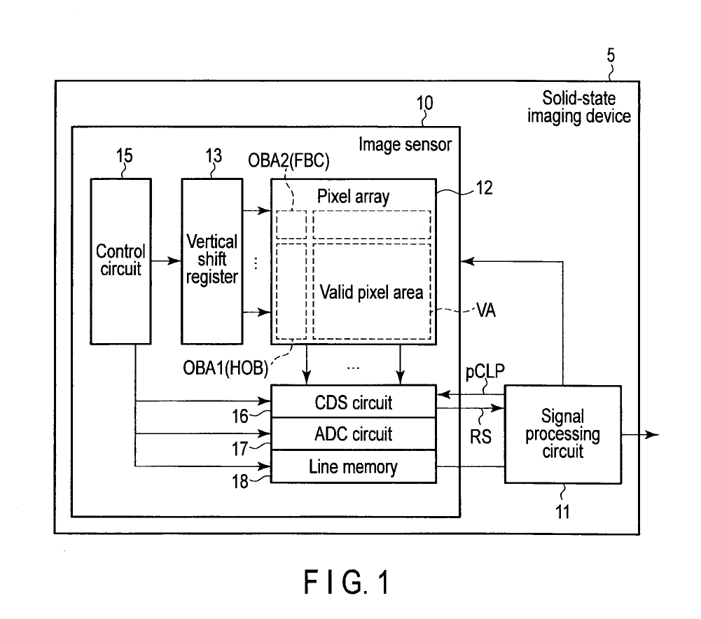

A solid-state imaging device according to a first embodiment and operations thereof will be described with reference to FIGS. 1 to 5.

(a) Configuration

A solid-state imaging device according to a first embodiment will be described with reference to FIGS. 1 to 4.

FIG. 1 is a block diagram schematically illustrating a configuration of the entire solid-state imaging device according to the first embodiment.

As illustrated in FIG. 1, the solid-state imaging device according to the first embodiment includes an image sensor 10 as a photographic imaging device and a signal processing circuit 11. The image sensor 10 is, for example, a backside illumination type CMOS image sensor. It is noted that the image sensor 10 may also be a CCD image sensor. The image sensor 10 may also be a frontside illumination type CMOS (or CCD) image sensor.

The image sensor 10 includes a pixel array 12, a vertical shift register 13, a control circuit 15, a correlation dual-sampling circuit (CDS circuit) 16, analog-digital converter circuit (ADC circuit) 17, and a line memory 18.

The pixel array 12 is provided in an imaging area of the image sensor 10. The pixel array 12 includes a plurality of pixels arranged in an array shape along a horizontal direction (row direction or X-direction) and a vertical direction (column direction or Y-direction) of the pixel array 12. The pixel array 12 of the image sensor 10 is internally provided with a valid pixel area VA that receives light from a subject and optical black (light-blocking pixel) areas (hereinafter, referred to as an “OB area”) OBA1 and OBA2 configured to generate a reference potential (e.g., black level) for signal processing.

The vertical shift register 13 sequentially scans rows of the pixel array 12 in a vertical direction in order to control reading of each pixel in the pixel array 12.

Each pixel has a photodiode as a photoelectric conversion element. The photodiode generates a signal charge depending on a light intensity incident to each pixel. The generated signal charge is subjected to noise reduction or analog-digital conversion through a CDS circuit 16 and an ADC circuit 17 and is converted into digital data (digital signal). The digital data is output to the signal processing circuit 11.

The line memory 18 holds signals (digital data) of pixels corresponding to a single line of the pixel array. The control circuit 15 controls operation timings of circuits 13, 16, 17, and 18 of the image sensor 10.

The signal processing circuit 11 performs, for example, lens shading correction, flaw correction, noise reduction, and the like for the digital data from the image sensor 10.

The data subjected to such signal processing is output to the outside of the solid-state imaging device and is feedback-controlled in the image sensor 10.

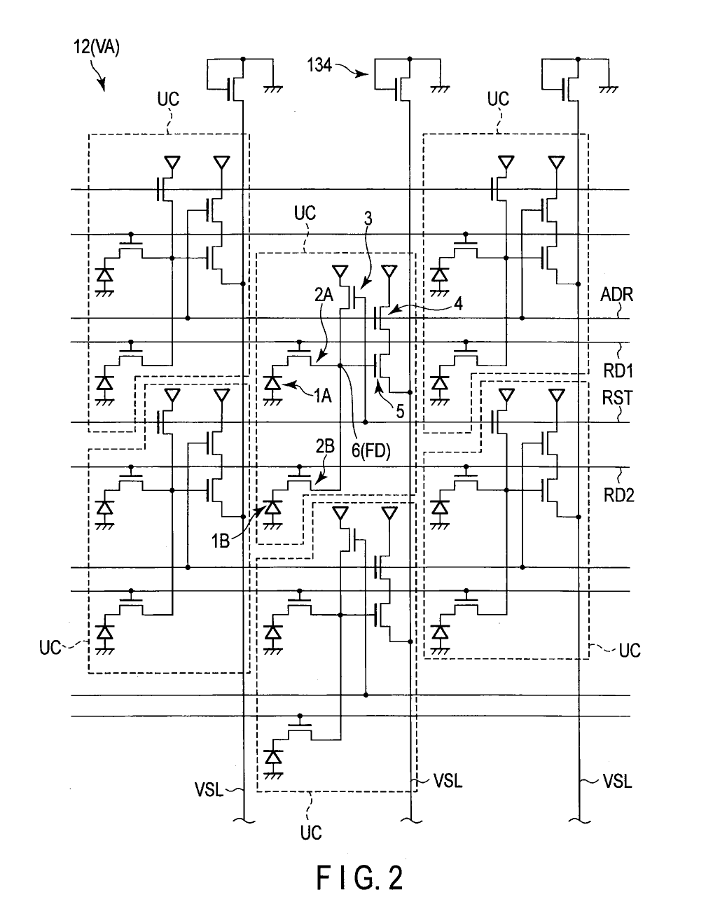

FIG. 2 is an equivalent circuit diagram illustrating an exemplary configuration of the pixel array 12 of the image sensor 10.

FIG. 2 is an equivalent circuit diagram schematically illustrating an internal configuration of the pixel array of the image sensor 10 according to the first embodiment. In FIG. 2, an internal configuration of the valid pixel area VA of the pixel array 12 is illustrated.

As illustrated in FIG. 2, a plurality of pixels 1A and 1B are arranged in a matrix shape inside the pixel array 12 of the image sensor according to the first embodiment.

According to the first embodiment, the pixel array 12 of the image sensor 10 has a two-pixel one-cell structure. The two-pixel one-cell structure has a circuit configuration that a single unit cell includes a pair of pixels.

A plurality of unit cells UC are arranged in a matrix shape inside the pixel array 12. Each unit cell UC is provided in a position where the control lines RD1, RD2, RST, and ADR intersect with the signal line VSL in the pixel array 12. The control lines RD1, RD2, RST, and ADR are provided in the pixel array 12 in order to supply a signal for controlling the operation (ON/OFF) of the unit cell UC to the unit cell UC. The signal line VSL is provided in the pixel array 12 in order to output a signal obtained through photoelectrical conversion of the photodiodes (pixels) 1A and 1B to the outside of the unit cell UC.

In the unit cell UC having a two-pixel one-cell structure, a single floating diffusion 6 as a signal detector 6 of the pixel (unit cell) is commonly used by a pair of photodiodes 1A and 1B. The unit cell UC includes, for example, a pair of read transistors 2A and 2B, a reset transistor 3, an address transistor 4, and an amplification transistor 5 in addition to the photodiodes 1A and 1B and the floating diffusion 6.

In the unit cell UC of the two-pixel one-cell structure, a pair of read transistors 2A and 2B are provided in the unit cell UC to match the photodiodes 1A and 1B, respectively. In the unit cell UC of the two-pixel one-cell structure, the reset transistor 3, the address transistor 4, and the amplification transistor 5 are shared by a pair of photodiodes 1A and 1B.

Anodes of the photodiodes 1A and 1B are connected to a fixed potential such as a ground potential. Cathodes of the photodiodes 1A and 1B are connected to the floating diffusion 6 as a signal detector through current paths of the read transistors 2A and 2B, respectively.

The photodiodes 1A and 1B convert incident light passing through a micro lens and a color filter at a certain wavelength range into a signal charge (electric signal) and store the charge. For example, the color filter has an arrangement pattern of a pigment film such as a Bayer pattern or a RGBW pattern. In the following description, unless specified otherwise, the photodiodes 1A and 1B are referred to as a photodiode 1.

Each read transistor 2A and 2B controls accumulation and transmission of the signal charges of each photodiode 1A and 1B. Gates of the read transistors 2A and 2B are connected to the read control lines RD1 and RD2, respectively. One end of the current path of the read transistors 2A and 2B is connected to the cathode of the photodiodes 1A and 1B, respectively. The other end of the current path of the read transistors 2A and 2B is connected to the floating diffusion 6. In the following description, unless specified otherwise, the read transistors 2A and 2B are referred to as a read transistor 2.

The reset transistor 3 resets the potential of the floating diffusion 6 (potential of the gate of the amplification transistor 5). The gate of the reset transistor 3 is connected to the reset control line RST. One end of the current path of the reset transistor 3 is connected to the floating diffusion 6. The other end of the current path of the reset transistor 3 is connected to, for example, a power line (power terminal) VDD. A detection signal of the floating diffusion having a reset state output from the unit cell UC when the floating diffusion 6 is reset is referred to as a “reset signal” (or reset voltage).

The address transistor 4 serves as a selection element for selecting (activating) the unit cell UC. A gate of the address transistor 4 is connected to the address control line ADR. One end of the current path of the address transistor 4 is connected to the other end of the current path of the amplification transistor 5. The other end of the current path of the address transistor 4 is connected to the power line VDD.

The amplification transistor 5 amplifies a signal from the photodiode 1 held by the floating diffusion 6. A gate of the amplification transistor 5 is connected to the floating diffusion 6. One end of the current path of the amplification transistor 5 is connected to the vertical signal line VSL. The other end of the current path of the amplification transistor 5 is connected to one end of the current path of the address transistor 4. The signal amplified by the amplification transistor 5 is output to the vertical signal line VSL as a signal of the unit cell (or pixel) UC via the amplification transistor 5 having an ON-state.

Each unit cell UC of the pixel array 12 of the image sensor may not include the address transistor 4. In this case, in the unit cell UC, the other end of the current path of the amplification transistor 5 is connected to the other end of the current path of the reset transistor 3 or the power terminal. When the unit cell UC does not include the address transistor 4, the address signal line ADR is not provided either.

The unit cell UC may have either a one-pixel one-cell structure having a single pixel or a circuit configuration (multi-pixel one-cell structure) having a single unit cell including three or more pixels (photodiodes) such as an four-pixel one cell structure and an eight-pixel one-cell structure. In the unit cell including a plurality of pixels, three or more photodiodes share a floating diffusion, a reset transistor, an amplification transistor, and an address transistor. In the unit cell having a plurality of pixels, a single read transistor is provided for each photodiode.

A pair of read control lines RD1 and RD2, the address control line ADR, and the reset control line RST are connected to the vertical shift register 13. The potentials (signal levels) of the read control lines RD1 and RD2, the address control line ADR, and the reset control line RST are controlled by the vertical shift register 13. A plurality of unit cells UC (and pixels) of the pixel array 12 are controlled and selected in units of rows.

The load transistor 134 is used as an current source of the vertical signal line VSL. One end of the current path of the load transistor 134 is connected to one end of the current path of the amplification transistor 5 via the vertical signal line VSL. The other end of the current path of the load transistor 134 is connected to the ground line Vss. The load transistor 134 has a diode connection such that the gate of the load transistor 134 is connected to the current path of the load transistor 134.

The vertical signal line VSL is connected to the CDS circuit 16 and the ADC circuit 17. Using the CDS circuit 16 and the ADC circuit 17, a noise is removed from the signal obtained from the unit cell UC and output to the vertical signal line VSL, and an analog signal from the unit cell UC is converted into a digital signal (digital data).

As the vertical signal line VSL is sequentially scanned in a horizontal direction by a horizontal shift register (not illustrated), the signal output to each vertical signal line is transmitted to a circuit in the rear stage via a horizontal signal line (not illustrated) at a predetermined timing. The digital data as an image signal RS generated by the image sensor 10 is output to the signal processing circuit 11. For example, when an arrangement pattern of the color filter is a Bayer pattern, the image signal (digital data) RS output from the image sensor 10 is also referred to as a raw signal (raw data).

The solid-state imaging device 5 according to the first embodiment can generate a YUV or RGB signal from the image signal RS obtained by the image sensor 10.

It is noted that, in the OB areas OBA1 and OBA2 of the pixel array 12, the unit cells having the same circuit configuration as the unit cells of the valid area VA are arranged in an array shape. However, the unit cells of the OB areas OBA1 and OBA2 are covered by a light-blocking film in order to prevent light from being incident to the unit cells of the OB areas OBA1 and OBA2.

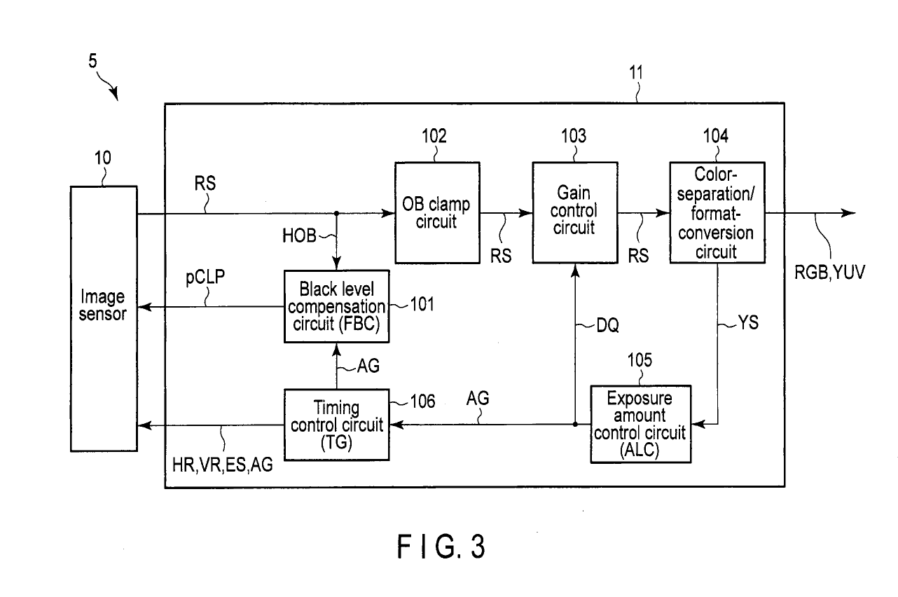

FIG. 3 is a block diagram illustrating a circuit for processing a signal output from the image sensor of the solid-state imaging device according to the first embodiment.

As illustrated in FIG. 3, the solid-state imaging device 5 according to the first embodiment includes circuits for processing the output signal (image signal or raw signal) of the image sensor 10, for examples, a black level compensation circuit (also referred to as a “feedback clamp circuit”) 101, an optical black clamp circuit 102, a gain control circuit 103, a color-separation/format-conversion circuit 104, an exposure amount control circuit (also referred to as an “automatic level control circuit”) 105, and a timing control circuit 106. Those circuits 101, 102, 103, 104, 105, and 106 are provided in the signal processing circuit 11.

In the following description, the black level compensation circuit 101 is also referred to as an FBC circuit, the optical black clamp circuit 102 is also referred to as an OB clamp circuit 102, the exposure amount control circuit 105 is also referred to as an ALC circuit 105, and the timing control circuit 106 is also referred to as a timing generator 106.

As illustrated in FIG. 1, the pixel array 12 of the image sensor 10 includes, as the OB areas OBA1 and OBA2, a horizontal light-blocking pixel area (hereinafter, referred to as a HOB pixel area) OBA1 used in the processing of the OB clamp circuit 102 and a horizontal light-blocking pixel area (hereinafter, referred to as an FBC pixel area) OBA2 used in the processing of the FBC circuit 101. The HOB pixel area OBA1 is adjacent to the valid pixel area VA in the horizontal direction (row direction) of the pixel array 12. For example, the light-blocking pixel area (hereinafter, referred to as a VOB light-blocking pixel area) is provided in the pixel array 12 to be adjacent to the FBC pixel area in the horizontal direction.

The HOB pixel area OBA1 and the FBC pixel area OBA2 are a light-blocking pixel area where light is not directly incident. On the light-receiving surface side, incident light is prevented from entering by covering the pixels of the HOB/FBC pixel areas OBA1 and OBA2 with a metal film (light-blocking film).

The FBC circuit 101 controls a clamp parameter pCLP for adjusting a black level reference, serving as a reference of the pixel signal at the time of photographic shooting, based on an output signal from the FBC pixel area OBA2. The clamp parameter pCLP is a coefficient for determining a reference voltage Vref when a CDS process and A/D conversion are performed for the pixel signal. The clamp parameter pCLP is supplied to the CDS circuit 16 and the ADC circuit 17.

In order to determine the clamp parameter pCLP, the FBC circuit 101 monitors a signal level of the pixel signal of the FBC pixel area OBA2 read from the image sensor 10 (hereinafter, referred to as an FBC pixel signal) and computes an average value of the FBC pixel signal.

When a difference is generated between the average value of the FBC pixel signal and the black level reference value set in advance, the FBC circuit 101 controls a magnitude of the clamp parameter pCLP such that the average value of the FBC pixel signal approaches the black level reference and feeds back the value of the clamp parameter pCLP to the image sensor 10. The image sensor 10 outputs, to the FBC circuit 101, the signal controlled using the clamp parameter pCLP fed back. Such a feedback process between the image sensor 10 and the FBC circuit 102 is repeated for each horizontal line (one row).

In the FBC circuit 101, the operation of controlling the clamp parameter pCLP using the output signal of the FBC pixel area OBA2 (hereinafter, referred to as an “FBC operation”) is executed within a read period before a signal of the valid pixel (hereinafter, referred to as a “valid pixel signal”) is output. The read period of the output signal of the FBC pixel area OBA2 for the FBC operation is set based on any number of lines (the number of FBC pixels included in a certain line, or the number of horizontal lines), and a feedback of the clamp parameter pCLP using the FBC circuit 101 is executed once per line (one horizontal line/one row, for example, a single read control line). For this reason, as the number of horizontal lines read within a read period in the FBC operation increases, the frequency of the FBC operation increases.

The OB clamp circuit 102 obtains signals of horizontal light-blocking pixels (HOB pixel) in a single horizontal line and signals of valid pixels subsequent to the HOB pixel and executes an OB clamping process using the parameter generated from the HOB pixel for the valid pixel signal. For example, the OB clamp circuit 102 corrects a black level of the image signal (valid pixel signal) on a single horizontal line basis by subtracting the average value of the signal level of the HOB pixel positioned at the head of the image signal in a single horizontal line from the valid image signal in the single horizontal line or adding the average value to the valid image signal.

The gain control circuit 103 controls a white balance or a digital gain DG of the image signal (digital data). The gain control circuit 103 controls each level (e.g., tone) of the valid image signal by executing processing using a certain parameter (e.g., multiplication of a parameter) for the valid image signal. The parameter for controlling the level of the valid image signal may include a setting value based on a command or a coefficient computed by the exposure amount control circuit 105.

The color-separation/format-conversion circuit 104 performs color separation for the image signal RS having a controlled gain to covert the image signal RS to an RGB or YUV signal. In addition, the color-separation/format-conversion circuit 104 extracts a luminance signal YS from the pixel (pixel signal) at the time of color separation.

The exposure amount control circuit (ALC circuit) 105 generates a control signal for controlling adjustment of the luminance of an image (screen). The exposure amount control circuit 105 determines a brightness of the image from an integration value within a VA (valid area or valid pixels) read period of the luminance signal extracted by the color-separation/format-conversion circuit 104 and controls the digital gain DG and the analog gain AG.

The timing control circuit 106 controls operation timings of the image sensor 10 and the signal processing circuit 11. The timing control circuit 106 generates a control signal ES for an electric shutter control timing, a control signal VR for a read timing of the image signal in the vertical direction of the image sensor 10, a control signal HR for the read timing of the image signal in the horizontal direction of the image sensor 10, and a control signal for the change timing of the analog gain AG or the like. The timing control circuit 106 outputs the generated control signal (pulse signal) to the image sensor 10 and a circuit in the signal processing circuit 11 such as the FBC circuit 101.

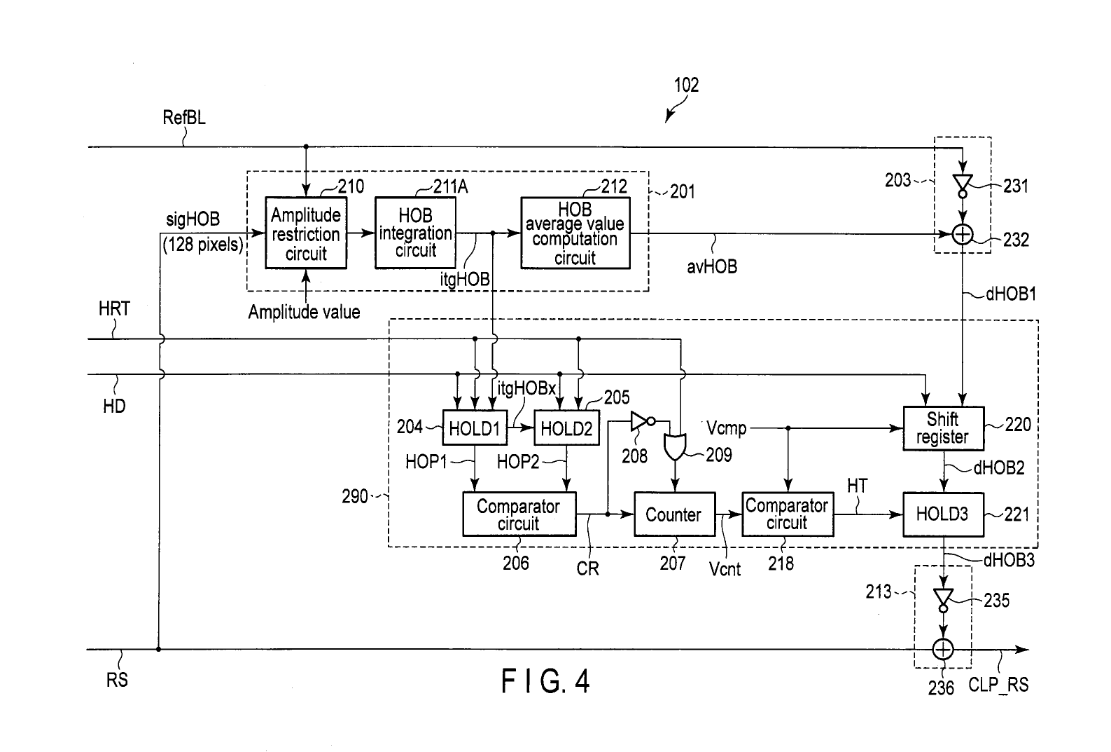

FIG. 4 is a block diagram illustrating an exemplary configuration of the OB clamp circuit 102 of the solid-state imaging device according to the first embodiment. The OB clamp circuit 102 has a HOB signal processing circuit 201.

The HOB signal processing circuit 201 includes an amplitude restriction circuit 210, a HOB pixel signal integration circuit 211A, and a HOB signal average value computation circuit 212.

The HOB signal processing circuit 201 executes a computation process for the output signal of the HOB pixels included at the head of the image signal (RAW data) RS from the image sensor 10 for each sampling period of a single horizontal line (row). For example, the image signal RS supplied to the HOB signal processing circuit 201 is an image signal RS subjected to the FBC process by feeding back a signal to the image sensor 10. However, in some cases, an image signal RS not subjected to the FBC process may be supplied to the OB clamp circuit 102.

A plurality of HOB pixel signals corresponding to the number of the HOB pixels in a single horizontal line of the HOB pixel area OBA1 are sequentially input to the HOB signal processing circuit 201 within a single sampling period for a single horizontal line. According to the first embodiment, the HOB pixel signals corresponding to 128 pixels are supplied as a HOB pixel signal for a single horizontal line of the HOB pixel area OBA1 to the HOB signal processing circuit 201.

The amplitude restriction circuit 210 performs amplitude restriction for the HOB pixel signal before the integration based on the black level reference value RefBL set by a command in advance. An amplitude value Vamp is supplied to the amplitude restriction circuit 210 for amplitude restriction. For example, when the black level reference value RefBL is set to d48, the amplitude restriction circuit 210 restricts the amplitude within a range of d24 to d72.

The HOB integration circuit 211A integrates the HOB pixel signals subjected to the amplitude restriction. The HOB pixel signal integration circuit 211A integrates a plurality (e.g., 128 pixels) of the HOB pixel signals included in the image signal RS for each sampling period of a single horizontal line (row) to generate an integration value of the HOB pixel signals (hereinafter, referred to as a “HOB integration value” or “HOB pixel signal integration value”).

The HOB average value computation circuit 212 computes an average value avHOB of the HOB pixel signals (hereinafter, referred to as a “HOB average value” or a “HOB pixel signal average value”) based on the HOB integration value itgHOB. The HOB average value computation circuit 212 outputs the HOB average value avHOB to the computation circuit 203 of the rear stage.

The HOB pixel average value avHOB is input to an adder circuit 232 of the computation circuit 203. A black level reference value RefBL is supplied to the adder circuit 232 via an inverter 231. The adder circuit 232 adds an inverse value of the black level reference value RefBL and the HOB average value avHOB.

Through the processing of computation circuit 203, the black level reference value RefBL is subtracted from the HOB average value avHOB to generate a first HOB difference value dHOB1.

The OB clamp circuit 102 of the solid-state imaging device according to the first embodiment has a circuit (hereinafter, referred to as a “detection circuit”) 290 for detecting an overflow of the signal charge from the valid pixel area to the OB area (here, the HOB pixel area).

The first hold circuit (HOLD1) 204 holds the HOB integration value itgHOB from the HOB integration circuit at the timing that the hold signal HD is asserted.

For example, the hold circuit 204 holds the value of the HOB integration value itgHOB at the timing of every 16th pixel (at a pixel interval of 16 pixels). It is noted that, although the assertion interval of the hold signal HD is set to the 16th pixel in the first embodiment, any other value (e.g., 8 pixels or 24 pixels) may also be set considering a specification of the image sensor (e.g., the number of HOB pixels in a single horizontal line), signal processing accuracy, and efficiency.

The signal hold state (hold state) of the first hold circuit 204 is reset by the hold reset signal HRT from the timing control circuit 106 at the timing that the head of the horizontal line is input (before the first pixel of the HOB pixel area is input).

The second hold circuit (HOLD2) 205 holds the output signal of the first hold circuit 204 at the timing that the hold signal HD is asserted (e.g., at a pixel interval of 16 pixels). The HOB integration value itgHOB held by the second hold circuit 205 is deviated by several pixels (here, 16 pixels) corresponding to the timing of holding the integration value from the HOB integration value itgHOB held by the first hold circuit 204. For example, when the first hold circuit 204 holds the HOB integration value itgHOB up to 48 pixels, the second hold circuit 205 holds the HOB integration value itgHOB up to 32 pixels. The signal hold state of the second hold circuit 205 is reset by the hold reset signal HRT at the timing that the head of the horizontal line is input (before the first pixel of the HOB pixel area is input).

The first comparator circuit 206 compares the magnitudes of the output signals HOP1 and HOP2 (HOB integration value itgHOB) of a pair of hold circuits 204 and 205.

When the output signal HOP1 of the first hold circuit 204 is larger than the output signal HOP2 of the second hold circuit 205, the first comparator circuit 206 asserts the output signal CR representing the comparison result and outputs, for example, an H-level (=“1”) signal to a counter 207. When the output signal HOP1 of the first hold circuit 204 is equal to or smaller than the output signal HOP2 of the second hold circuit 205, the comparator circuit 206 outputs an L-level (=“0”) signal as a comparison result CR to the counter 207.

The counter 207 counts the frequency of the comparison result CR representing that the output signal HOP1 of the first hold circuit 204 is larger than the output signal HOP2 of the second hold circuit 205 in the comparator circuit 206. In the following description, the counter 207 that counts the frequency of the comparison result will be referred to as a “comparison result counter” 207.

The count operation of the counter 207 is controlled based on the output signal (comparison result) CR of the comparator circuit 206 and the hold reset signal HRT. The control signal of the counter 207 is generated by an OR-gate 209. The output signal CR of the comparator circuit 206 (comparison result of the HOB integration value) is supplied to one of the input terminals of the OR gate 209 via an inverter 208, and the hold reset signal HRT is supplied to the other input terminal of the OR-gate 209.

For example, during an integration process (the count operation of the counter 207) of the HOB pixel signal, the hold reset signal HRT is set to an L-level (=“0”). When an H-level signal CR representing that the output signal HOP1 of the first hold circuit 204 is larger than the output signal HOP2 of the second hold circuit 205 is output from the comparator circuit 206, the L-level signal is supplied to the OR-gate 209 via the inverter 208. Due to the hold reset signal HRT having an L-level and the L-level signal, the OR-gate 209 outputs an L-level signal to the counter 207.

When an L-level signal CR representing that the output signal HOP1 of the first hold circuit 204 is equal to or smaller than the output signal HOP2 of the second hold circuit 205 is output from the comparator circuit 206, an H-level signal is supplied from the inverter 208 to the OR-gate 209. Due to the hold reset signal HRT having an L-level and the H-level signal, the OR-gate 209 outputs the H-level signal to the counter 207.

In this manner, during the operation of the counter 207, the OR-gate 209 generates signals having different levels depending on the comparison result CR of the comparator circuit 206.

The comparison result counter 207 counts up the held count value Vcnt if the comparison result CR between the output signals HOP1 and HOP2 of a pair of hold circuits 204 and 205 is asserted at the timing that the hold signal HD is asserted. If the comparison result CR between the output signals HOP1 and HOP2 of a pair of hold circuits 204 and 205 is de-asserted, the comparison result counter 207 resets the held count value Vcnt based on the H-level signal from the OR-gate 209.

The second comparator circuit (hereinafter, referred to as a “determination circuit”) 218 compares the comparison value Vcmp set in advance and the count value Vcnt of the comparison result counter 207. When the count value Vcnt of the comparison result counter 207 is equal to or larger than the comparison value Vcmp, the second comparator circuit 218 asserts a signal HT (hereinafter, referred to as a “hold timing signal” or a “difference value hold signal”) for controlling the timing of holding the HOB difference value. The second comparator circuit 218 supplies the hold timing signal to the third hold circuit 221.

It is noted that the comparison value Vcmp as a determination value is set based on an allowable value computed in advance based on a test result and a specification of the image sensor. For example, the comparison value Vcmp is set to “2” or “3.” However, the comparison value Vcmp may change depending on a size of the HOB pixel area OBA1 (the number of the HOB pixels of a single horizontal line).

The shift register 220 holds the first HOB difference value dHOB1 supplied from the computation circuit 203, for example, at the timing synchronized with the hold signal HD, here, at a pixel interval of 16 pixels. The shift register 220 shifts the first HOB difference value dHOB1 by the value specified by the comparison value Vcmp and holds shifted value as the second HOB difference value dHOB2. The difference value held by the shift register 220 is updated at the timing that the output signal from the computation circuit 203 is received (at a pixel interval of 16 pixels) and is sequentially rewritten as the integration process of the HOB signal advances.

The shift register 220 serves as a delay circuit (buffer or timing control circuit) for controlling the output timing of the computation result of the computation circuit 203 to the third hold circuit 221 from the first computation circuit 203. That is, the shift register 220 delays the signal transmission timing to the third hold circuit 221 from the timing that a signal is received from the first computation circuit 203 (or the determination timing of the comparator circuits 206 and 218) by a value corresponding to the comparison value Vcmp.

The third hold circuit (HOLD3) 221 holds the second HOB difference value dHOB2 output from the shift register 220 when the output signal HT (hold timing signal) of the comparator circuit 218 is asserted. The third hold circuit 221 does not receive the output from the shift register 220 when the output signal of the comparator circuit 218 is de-asserted.

The second HOB difference value dHOB2 supplied to the third hold circuit 221 is the first HOB difference value dHOB1 at the timing shifted depending on a value specified by the comparison value Vcmp supplied to the shift register 220. For example, when the comparison value Vcmp is set to “2,” the second HOB difference value dHOB2 output to the hold circuit 221 from the shift register 220 is the HOB difference value delayed by a second round timing from the HOB integration value creation timing at which the comparator circuit 206 or 218 detects an overflow of the signal charge.

It is noted that the third hold circuit 221 continuously holds a value without updating the hold value if the HOB difference value is held once during the processing for a single horizontal line.

The third hold circuit 221 outputs the held second HOB difference value dHOB2 to the second computation circuit 213 as a third HOB difference value dHOB3.

The second and third HOB difference values dHOB2 and dHOB3 are values obtained by performing integration until an overflow of the signal charge from the valid pixel to the HOB pixel is detected (before the count value becomes equal to or larger than the comparison value). That is, the second and third HOB difference values dHOB2 and dHOB3 are values generated from the output signal of the light-blocking pixel that is not influenced or little influenced by the overflow of the signal charges from the valid pixel.

The HOB pixel signal is integrated from the head (terminated end of the pixel array) of the horizontal line (row) to a boundary between the HOB pixel area OBA1 and the valid pixel area VA. For this reason, when an overflow of the signal charge (or leakage of light) from the valid pixel area VA to the HOB pixel area OBA1 occurs, the HOB pixel signal integration value itgHOB abruptly increases as the integration process advances. Accordingly, the HOB average value avHOB also increases.

If the comparison result CR is continuously obtained such that the output signal HOP1 of the first hold circuit 204 of the comparator circuit 206 is larger than the output signal HOP2 of the second hold circuit 205, it means that it is highly likely that the HOB pixel used in the signal integration is influenced by the overflow of the signal charges as the integration advances from the head of the horizontal line (the area far from the valid pixel area) to the boundary between the valid pixel area and the HOB pixel area.

When the count value Vcnt of the counter 207 is continuously counted up, and the count value Vcnt becomes equal to or larger than the comparison value Vcmp, it is highly likely that a HOB difference value dHOB1 is generated using the HOB integration value (average value) itgHOB including the output signal of the HOB pixel influenced by the overflow of the signal charges from the valid pixel area VA to the HOB pixel area OBA1 and the integration value (average value) itgHOB thereof. Therefore, the setting timing of the HOB difference value dHOB3 used in the OB clamping process is controlled based on the determination result between the count value Vcnt and the comparison value. In this manner, it is possible to detect an overflow of the signal charge from the valid pixel to the HOB pixel and selectively obtain a parameter that is obtained from the HOB pixel having substantially not influence of the overflow of the signal charge from the valid pixel based on the detection result.

The second computation circuit 213 performs a computation process for the third HOB difference value dHOB3 and the pixel signal RS to generate an image signal RS(CLP_RS) subjected to the OB clamping process.

For example, the computation circuit 213 includes an inverter 235 and an adder 236. The third HOB difference value dHOB3 is supplied to the adder circuit 236 of the second computation circuit 213 via the inverter 235. The adder circuit 236 adds an inverse value of the third HOB difference value dHOB3 to the pixel signal (valid pixel signal) RS. That is, the computation circuit 213 subtracts the third HOB difference value dHOB3 from the image signal RS (e.g., valid image signal subjected to the FBC process). The second computation circuit is also referred to as a “processing circuit.”

In this manner, the third HOB difference value dHOB is used as a parameter to generate the pixel signal CLP_RS subjected to the OB clamping process by the second computation circuit 213.

The image signal CLP_RS subjected to the signal processing for the black level is output to a circuit (e.g., gain control circuit 103) of the rear stage from the OB clamp circuit 102.

In order to execute the OB clamping process with high accuracy, it is preferable that the parameter for the OB clamping process (here, the HOB difference value) be set using more the output signals of the HOB pixels having a less influence of the overflow of the signal charge.

It is noted that, when the count value is not larger than the determination value Vcmp during the processing period for the pixel signal of the HOB pixel of a single horizontal line in the OB clamp circuit 102, the third hold circuit 221 obtains the HOB difference value held by the shift register 220 (here, a value obtained from the HOB pixel signal of 128 pixels) and supplies the HOB difference to the computation circuit 213 of the rear stage at the timing that the computation process for the pixel signal of a plurality of HOB pixels (here, 128 pixels) included in a single horizontal line is terminated, for example, under control of the timing control circuit 106.

When light having high luminance (e.g., light having luminance higher than a saturation light intensity of the photodiode) is irradiated onto the valid pixel area, or an interval between the valid pixel and the OB pixel is reduced due to miniaturization of the pixel, in the vicinity of the boundary between the valid pixel area and the light-blocking pixel area (HOB pixel area), there is a possibility that the signal charge overflows from the valid pixel area to the light-blocking pixel area, and the signal charge photoelectrically converted by the pixels of the valid pixel area may be accumulated in the pixels of the light-blocking pixel area.

As the signal charges overflowing from the valid pixel area to the light-blocking pixel area are accumulated in the light-blocking pixels in the vicinity of the boundary between the valid pixel area and the light-blocking pixel area, the output signal of the light-blocking pixel where the signal charges overflowing from the valid pixel are accumulated increases, so that the integration value and the average value of the signal level of the light-blocking pixel increase. For this reason, in the vicinity of the boundary between the valid pixel area and the light-blocking pixel area, the light-blocking pixel is influenced by the overflow of the signal charge, and the value of the parameter used in the clamping process for the image signal of the valid pixel area generated from the output signal of the light-blocking pixel increases.

This lowers the signal level of the image signal subjected to the OB clamping process, so that a dark image is obtained.

The OB clamp circuit of the solid-state imaging device according to the first embodiment has a function (circuit or block) of determining whether or not there is an overflow of the signal charge from the valid pixel area to the light-blocking pixel (e.g., HOB pixel area) based on the signal processing (computation process) for the output signal of the light-blocking pixel (HOB pixel).

According to the first embodiment, the OB clamp circuit compares the value (here, HOB pixel signal integration value) obtained from the output signal of the light-blocking pixel in the boundary side between the valid pixel area and the light-blocking pixel area and the value obtained from the output signal of the light-blocking pixel of the side opposite to the boundary side (head side of the horizontal line) so as to detect the light-blocking pixel influenced by the overflow of the signal charge from the valid pixel.

If it is determined that it is highly likely that the light-blocking pixel is influenced by the overflow of the signal charge from the valid pixel, the OB clamp circuit of the solid-state imaging device according to the first embodiment executes the OB clamping process for the image signal using a parameter (here, HOB difference value) generated from the value obtained from the output signal of the light-blocking pixel determined as having no influence of the overflow of the signal charge.

In this manner, the solid-state imaging device according to the first embodiment can execute the OB clamping process using the parameter obtained from the light-blocking pixel having no influence of the overflow of the signal charge from the valid pixel to the light-blocking pixel in the vicinity of the boundary between the valid pixel area and the light-blocking pixel area, out of a plurality of light-blocking pixels, by detecting generation of an overflow of the signal charge from the valid pixel to the light-blocking pixel. As a result, using the solid-state imaging device according to the first embodiment, it is possible to suppress degradation of the signal level of the image signal subjected to the OB clamping process and generation of an image having a dark tone.

As described above, using the solid-state imaging device according to the first embodiment, it is possible to improve an image quality of the image formed by the solid-state imaging device.

(b) Operation

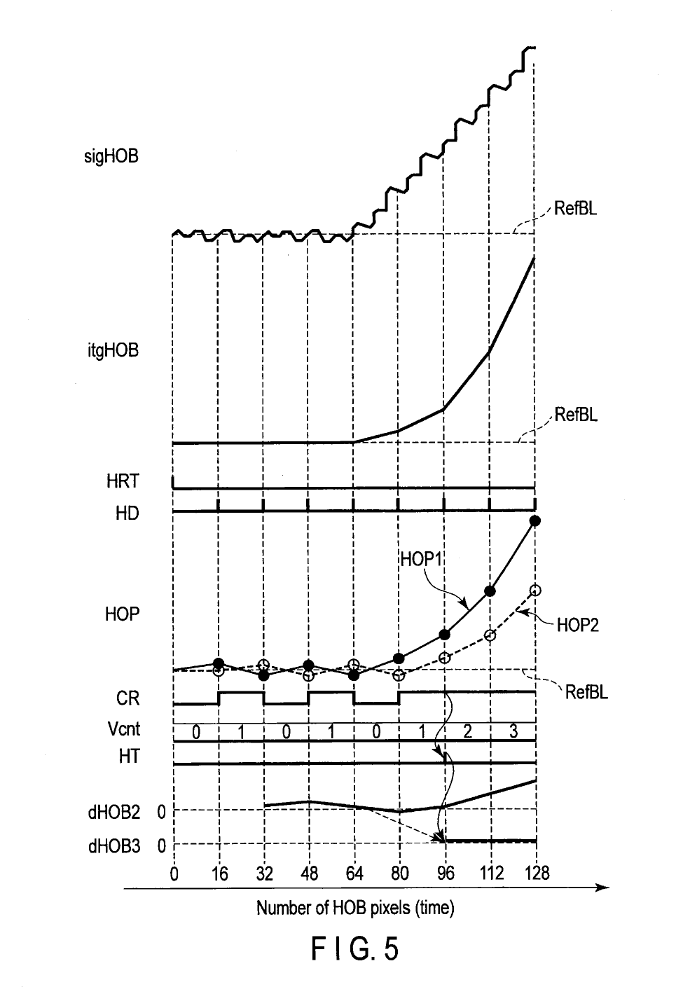

An operation (control method) of the solid-state imaging device according to the first embodiment will be described with reference to FIG. 5. Here, in addition to FIG. 5, FIGS. 1 to 4 are also used as necessary to describe the operation of the solid-state imaging device according to the first embodiment.

FIG. 5 is a diagram illustrating the operation of the OB clamp circuit in the solid-state imaging device according to the first embodiment. In FIG. 5, the abscissa denotes the number of light-blocking pixels in a single horizontal line and a sampling timing (time) of the signal, and the ordinate denotes a magnitude of each signal.

For example, a CDS process and an ADC process are performed for the electric signal generated from the light obtained from the subject using the photodiode of the image sensor of the solid-state imaging device, so that an image signal RS of the image sensor is generated. The image signal RS includes the HOB pixel signal of the HOB pixel area OBA1 and the valid pixel signal of the valid pixel area VA. For example, the image signal RS includes the HOB pixel signals corresponding to 128 pixels.

It is noted that the FBC pixel signal of the OB area OBA2 is supplied to the signal processing circuit 11 from the image sensor 10, and the FBC process is executed by the FBC circuit 101 before a signal processing for the image signal is executed using the HOB pixel signal for the image signal RS including the HOB pixel signal and the valid pixel signal. As a result, a clamp parameter pCLP for determining a reference voltage for the CDS/ADC process is controlled. Therefore, according to the first embodiment, the image signal RS including the HOB pixel signal and the valid pixel signal are signals subjected to the FBC process.

The image signal RS including the HOB pixel signal and the valid pixel signal is supplied to the OB clamp circuit 102. The OB clamp circuit 102 executes the OB clamping process using the supplied image signal RS.

As illustrated in FIG. 5, at the timing that the HOB pixel signal of the image signal RS is supplied to the OB clamp circuit 102, the hold reset signal HRT having an H-level is supplied to the OB clamp circuit. As a result, the hold circuits 204 and 205 and the counter 207 of the detection circuit of the OB clamp circuit 102 are reset before the processing in the OB clamp circuit 102 using the HOB pixel signal.

The HOB pixel signal sigHOB positioned at the head of a single horizontal line in the image signal RS is supplied to the HOB pixel signal processing circuit 201. The amplitudes of the signals sigHOB of each HOB pixel of the HOB pixel area OBA1 are restricted by the amplitude restriction circuit 210 based on the black level reference value RefBL and the amplitude Vamp.

The HOB pixel signals sigHOB subjected to the amplitude restriction are supplied to the HOB integration circuit 211 and are sequentially integrated. As a result, the HOB integration value itgHOB (HOB pixel signal integration value) is generated.

The generated HOB integration value itgHOB is supplied to the HOB average value computation circuit 212. The HOB integration value itgHOB is divided by integration frequency (number of pixels) so that the signal levels of the HOB pixels of a single horizontal line are averaged. As a result, the HOB average value (HOB pixel signal average value) avHOB is generated by the HOB average value computation circuit.

The HOB average value avHOB is supplied to the computation circuit 203 of the rear stage from the HOB pixel signal processing circuit 201. A computation process using the computation circuit 203 is performed for the HOB average value avHOB and the black level reference value RefBL. The computation circuit 203 subtracts the black level reference value RefBL from the HOB average value avHOB to generate the HOB difference value (HOB pixel signal difference value) dHOB1.

Along with the computation process of the HOB average value avHOB, the HOB integration value itgHOB is supplied to the first hold circuits 204.

At the timing that the HOB integration value itgHOB of the HOB pixel signals corresponding to 16 pixels is generated, the hold signal HD is asserted. The hold signal HD is asserted at an interval of 16 HOB pixels, and an H-level signal is supplied to the first and second hold circuits 204 and 205.

At the timing that the hold signal HD is asserted, the HOB integration value itgHOB at an interval of 16 pixels is received by the hold circuit 204.

In addition, at the timing that the hold signal HD is asserted, the HOB integration value itgHOBx held by the first hold circuit 204 is received by the second hold circuit 205.

The HOB integration value itgHOB (hold value) held by the first hold circuit 204 and the HOB integration value itgHOB (hold value) held by the second hold circuit 205 are deviated by 16 pixels. For example, when the HOB integration value itgHOB of the first hold circuit 204 is the integration value of the HOB pixels for 80 pixels of a single horizontal line, the HOB integration value itgHOBx of the second hold circuit 205 is the integration value of the HOB pixels up to 64 pixels of a single horizontal line. The HOB pixel signal integration value itgHOBx held by the first hold circuit 204 is the integration value including a signal value corresponding to the signal charge accumulated in the HOB pixel positioned in the vicinity of the boundary (terminated end side of the HOB pixel area) between the valid pixel area VA and the HOB pixel area OBA1, compared to the HOB pixel signal integration value itgHOBx held by the second hold circuit 205.

At the timing of every 16th pixel, the HOB integration value held by the first hold circuit 204 is received by the second hold circuit 205, and the integration value generated by the HOB integration circuit 211A is newly received by the first hold circuit 204. It is noted that, when the first HOB integration value is held by the first hold circuit 204 during the processing for a single horizontal line, a value output to the second hold circuit 205 from the first hold circuit 204 in synchronization with that timing is a value (e.g., zero) obtained by resetting the first hold circuit 204.

Substantially simultaneously as the HOB integration values itgHOB and itgHOBx are held by the first and second hold circuits 204 and 205, the first HOB difference value dHOB1 from the computation circuit 203 is received by the shift register 220 at the timing that the hold signal HD is asserted. The first HOB difference value dHOB1 updated at every 16th pixel is held by the shift register 220.

The output signal (hold value) HOP1 of the first hold circuit 204 and the output signal (hold value) HOP2 of the second hold circuit 205 are supplied to the comparator circuit 206. A magnitude relationship between the output signals HOP1 and HOP2 of a pair of hold circuits 204 and 205 is compared by the comparator circuit 206.

When the output signal HOP1 of the first hold circuit 204 is larger than the output signal HOP2 of the second hold circuit 205, the output signal CR representing the comparison result CR of the comparator circuit 206 is asserted, so that an H-level signal is supplied to the counter 207.

Meanwhile, when the output signal HOP1 of the first hold circuit 204 is equal to or smaller than the output signal HOP2 of the second hold circuit 205, the output signal CR representing the comparison result CR of the comparator circuit 206 is de-asserted, so that an L-level signal is supplied to the counter 207.

The comparison result CR of the comparator circuit 206 is supplied to the counter 207 and is also supplied to the OR-gate 209 via the inverter 208. An inverse signal of the comparison result CR and the hold reset signal HRT are input to the OR-gate 209. The output signal of the OR-gate 209 is supplied to the counter 207 as a control signal of the counter 207.

For example, as in the timing that the integration value of the output signal (signal charge) of the HOB pixels up to the 16th pixel is generated, when the output signal HOP1 of the output signal of the first hold circuit 204 is larger than the output signal HOP2 of the second hold circuit 205, the count value Vcnt of the counter 207 is counted up based on the signal CR having an asserted state from the comparator circuit 207.

When the signal CR having a de-asserted state is output from the comparator circuit 207, the count value Vcnt of the counter 207 is reset based on the L-level output signal of the OR-gate 209 as a control signal. For example, as in the timing that the integration value of the signals of the HOB pixels up to the 32nd pixel is generated, when the output signal HOP1 of the first hold circuit 204 is equal to or smaller than the output signal HOP2 of the second hold circuit 205, the count value Vcnt of the counter 207 is reset.

The count value Vcnt of the counter 207 is supplied to the comparator circuit (determination circuit) 218. The count value Vcnt is compared with the comparison value Vcmp of the comparator circuit 218.

When the count value Vcnt is smaller than the comparison value Vcmp, the hold timing signal HT corresponding to the comparison result of the comparator circuit 218 is de-asserted.

When the count value Vcnt is equal to or larger than the comparison value Vcmp, the hold timing signal HT is asserted.

In the example of FIG. 5, the influence of the overflow (or leakage of light) of the signal charge from the valid pixel to the HOB pixel starts to be generated from the HOB pixel after the 64th pixel, and the signal level (output signal) sigHOB of each HOB pixel signal gradually increases. The influence of the overflow (or leakage of light) of the signal charge from the valid pixel is not nearly generated for the HOB pixel before the 64th pixel.

In the case where the comparison value Vcmp is set to “2”, as in the HOB integration value itgHOB up to the 80th pixel and the 96th pixel, it is determined by the detection circuit 290 that a leakage of the signal charge from the valid pixel area is generated in the HOB pixels in the vicinity of the boundary between the valid pixel area and the HOB pixel area when the state that the output signal HOP1 of the first hold circuit 204 is larger than the output signal HOP2 of the second hold circuit 205 occurs two times in sequence (when the count value Vcnt is “2”).

The HOB difference value of the shift register 220 having a timing shifted depending on the comparison value

Vcmp due to the asserted hold timing signal HT is received by the third hold circuit 221 as a second HOB difference value dHOB2. For example, when the count value Vcnt is the same value as the comparison value Vcmp for the integration value generated from the HOB pixels up to the 96th pixel, the difference value generated at the timing shifted by the comparison value Vcmp, that is, in this case, the HOB difference value generated from the HOB pixel signal up to the 64th pixel is supplied to the third hold circuit 221. For example, the timing control circuit 106 of the signal processing circuit 11 can recognize that the HOB difference value is stored in the third hold circuit 221.

The value held by the third hold circuit 221 is supplied to the computation circuit 213 in the rear state as a third HOB difference value dHOB3. For example, at the timing that the HOB difference value dHOB2 is received by the third hold circuit 221, the clamping process for the image signal RS starts.

Through the computation process of the computation circuit 213, the third HOB difference value dHOB3 is subtracted from the valid pixel signal of the image signal RS (e.g., the image signal subjected to the FBC process) so that an image signal CLP_RS subjected to the OB clamping process is generated.

It is noted that, once the HOB difference value is received by the third hold circuit 221, the HOB difference value received by the third hold circuit 221 is not updated to the HOB difference value received by the shift register 220 from the computation circuit 203 even when the output signals HOP1 and HOP2 of a pair of hold circuits 204 and 205 are continuously compared at the time of the OB clamping process for a single horizontal line.

The HOB difference value dHOB3 supplied from the third hold circuit 221 to the computation circuit 213 is a value (parameter) generated from the signal of the HOB pixel that receives almost no signal charge overflowing from the valid pixel area VA to the HOB pixel area OBA1.

Therefore, the image signal CLP_RS generated by the OB clamp circuit 102 of the solid-state imaging device according to the first embodiment and subjected to the OB clamping process is little influenced by the signal charge from the valid pixel area VA to the HOB pixel area OBA1.

It is noted that, when the count value Vcnt does not exceed the comparison value Vcmp, it is highly likely that the influence caused by the overflow of the signal charge from the valid pixel area to the HOB pixel area is not generated. For this reason, for example, the HOB difference value dHOB1 obtained from the output signals of all HOB pixels included in a single horizontal line is directly received by the third hold circuit 213 due to control of the timing control circuit 106. This value is supplied from the third hold circuit 221 to the computation circuit 213, and a signal processing for the image signal RS is executed.

The image signal CLP_RS subjected to the OB clamping process is supplied to the gain control circuit 103 in the rear stage.

The OB clamping process for each horizontal line as described above is repeatedly executed until the image signal corresponding to a single frame of the image sensor is formed.

In the operation of the OB clamp circuit of the solid-state imaging device according to the first embodiment, the value (here, HOB pixel signal integration value) obtained from the output signal of the light-blocking pixel in the boundary side between the valid pixel area VA and the light-blocking pixel area (here, HOB pixel area) OBA1 is compared with the value obtained from the output signal of the light-blocking pixel in the side opposite to the boundary side (head side of the horizontal line).

As a result, according to the first embodiment, it is possible to detect the influence of the overflow of the signal charge from the valid pixel to the light-blocking pixel in the boundary area between the valid pixel area VA and the light-blocking pixel area OBA1.

According to the first embodiment, if the influence of the overflow of the signal charge from the valid pixel to the light-blocking pixel is detected, the OB clamping process for the image signal is executed using the parameter (HOB difference value) generated by the OB clamp circuit 102 through the processing before the influence of the overflow of the signal charge is detected.

Therefore, in the operation of the solid-state imaging device according to the first embodiment, it is possible to execute the OB clamping process for an image signal using a value generated from a signal of the HOB pixel having nearly no influence of the overflow of the signal charge from the valid pixel area VA to the HOB pixel area OBA1, caused by a large light intensity, miniaturization of an element, and the like.

As a result, according to the first embodiment, it is possible to suppress an excessive decrease of the image signal level subjected to the OB clamping process due to the overflow of the signal charge from the valid pixel area VA to the HOB pixel area OBA1 or generation of an image having a dark tone.

Therefore, in the method of controlling the solid-state imaging device according to the first embodiment, it is possible to improve an image quality of an image formed by the solid-state imaging device.

### (2) Second Embodiment

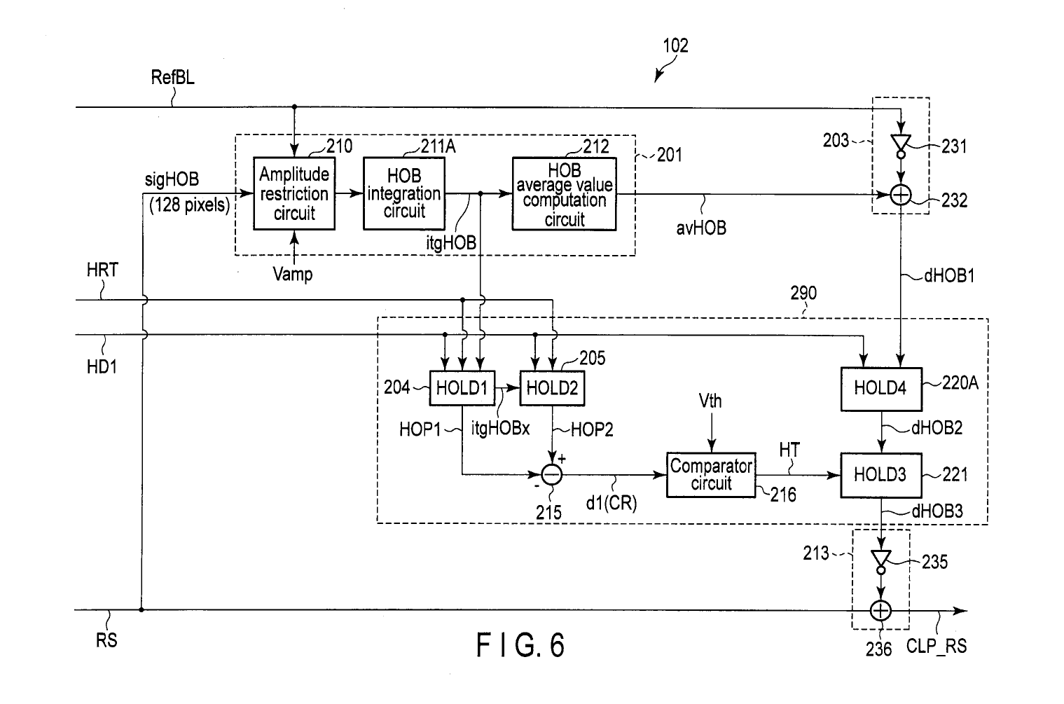

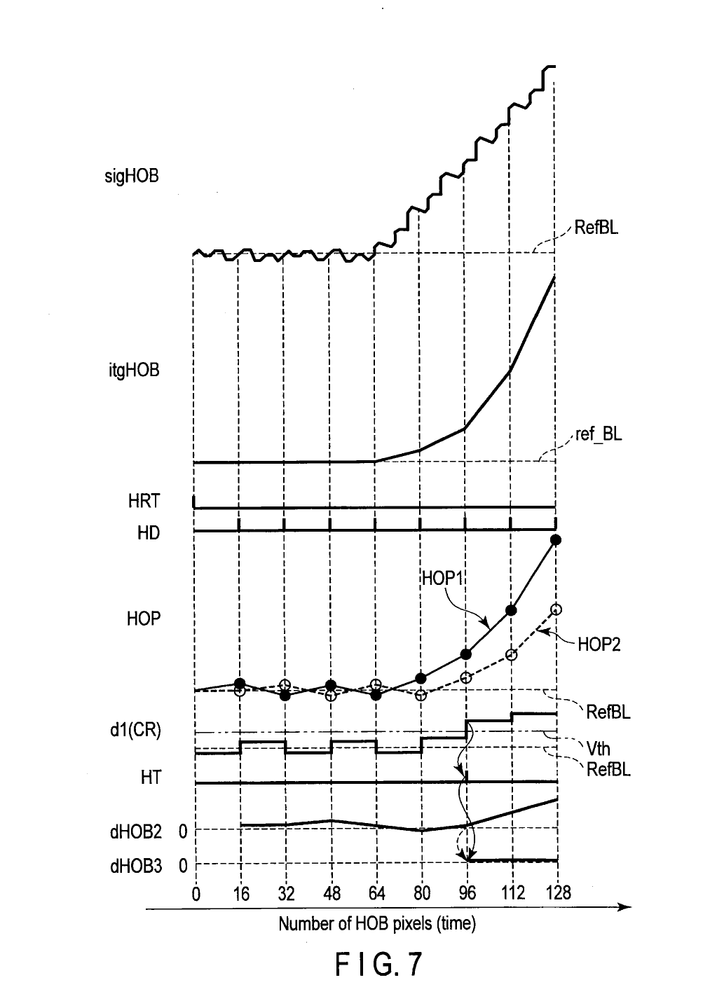

A solid-state imaging device according to a second embodiment will be described with reference to FIGS. 6 and 7.

In the second embodiment, the description will not be repeated for substantially the same configuration, function, and operation as those of the solid-state imaging device according to the first embodiment.

FIG. 6 is a block diagram illustrating an internal configuration of the OB clamp circuit included in the solid-state imaging device according to the second embodiment.

The OB clamp circuit 102 of the solid-state imaging device according to the second embodiment is different from that of the solid-state imaging device according to the first embodiment in that whether or not there is a leakage of the signal charge from the valid pixel area to the light-blocking pixel area (HOB pixel area) is determined based on a comparison result between a computation result for the HOB integration values held by a pair of hold circuits 204 and 205 and a certain threshold value.

As illustrated in FIG. 6, in the detection circuit 290 included in the OB clamp circuit 102, the output signals HOP1 and HOP2 of the first and second hold circuits 204 and 205 are output to the third computation circuit 215.

The third computation circuit 215 is, for example, a subtraction circuit 215 that executes a subtraction process using the output signal HOP1 of the first hold circuit 204 and the output signal HOP2 of the second hold circuit 205. For example, the subtraction circuit 215 subtracts the output signal HOP1 of the first hold circuit 204 from the output signal HOP2 of the second hold circuit 205. The difference value d1 representing the computation result CR of the computation circuit (subtraction circuit) 215 is output to the comparator circuit 216.

The comparator circuit 216 compares the output signal (computation result) d1 of the computation circuit 215 and a setting threshold value Vth. The threshold value Vth is set based on an allowable difference between the black level reference value RefBL and the difference value of the signal level of the HOB pixel. It is noted that the threshold value Vth as a determination value is a value set from an allowable value computed in advance based on a test result and a specification of the image sensor, and the like.

According to the second embodiment, instead of the shift register for holding the computation result (HOB difference value dHOB1) of the first computation circuit 203, a fourth hold circuit (HOLD4) 220A is provided in the OB clamp circuit 102. The fourth hold circuit 220A as a timing control circuit (buffer) is provided to control the output timing of the HOB difference value to the third hold circuit 221 from the computation circuit 203. The fourth hold circuit 220A is connected between the first computation circuit 203 and the third hold circuit 221.

The fourth hold circuit 220A holds the first HOB difference value dHOB1 from the first computation circuit 203 by using the hold signal HD as a control signal. The fourth hold circuit 220A holds the HOB difference value dHOB1 from the computation circuit 203 at the timing based on the hold signal HD and outputs the difference value received by the hold circuit 220A to the third hold circuit 221 in the rear stage as a second HOB difference value dHOB2. The difference value held by the fourth hold circuit 220A is updated at the timing (at a pixel interval of 16 pixels) that the output signal from the computation circuit 203 is received and is sequentially rewritten as the integration process of the Hold signal advances.

The third hold circuit 221 holds the second HOB difference value dHOB2 from the fourth hold circuit 220A at the timing that the output of the comparator circuit 216 is asserted. In addition, the third hold circuit 221 outputs the second HOB difference value dHOB2, that is held, as a third HOB difference value dHOB3.

The HOB integration value held by the first hold circuit 204 increases due to the influence of the overflow of the signal charge. As a result, when the output signal d1 of the computation circuit 215, that is, the difference value between the output signals HOP1 and HOP2 of the first and second hold circuits 204 and 205 is larger than the threshold value Vth, the comparator circuit 216 asserts the hold timing signal HT. The hold circuit 221 is activated in response to the assertion signal HT of the comparator circuit 216.

When the output signal d1 of the subtraction circuit 215 is equal to or smaller than the threshold value Vth, the comparator circuit 216 de-asserts the hold timing signal HT.

In addition, a computation process between the HOB difference value dHOB3 and the image signal (valid pixel signal) RS is performed, so that, for example, the HOB difference value dHOB3 is subtracted from the pixel signal RS.

As a result, the OB clamping process is executed using a parameter generated from the output signal of the light-blocking pixel (here, HOB pixel) having nearly no influence of the overflow of the signal charge to the light-blocking pixel area in the vicinity of the boundary between the valid pixel area VA and the light-blocking pixel area OBA1.

FIG. 7 is a diagram illustrating an operation of the OB clamp circuit in the solid-state imaging device according to the second embodiment. In FIG. 7, the abscissa denotes the number of light-blocking pixels in a single horizontal line and a sampling timing (time) of the signal, and the ordinate denotes a magnitude of each signal.

As illustrated in FIG. 7, similar to the first embodiment, the HOB integration value is received by the hold circuits 204 and 205 at the timing that the hold signal HD is asserted. Then, a computation process between the HOB integration value itgHOB of the first hold circuit 204 and the HOB integration value itgHOBx of the second hold circuit 205 is executed by the computation circuit 215.

When the output signal HOP1 of the first hold circuit 204 that holds the integration value of the HOB pixel signal up to the boundary side between the valid pixel area VA and the HOB pixel area OBA1 is larger than the output signal HOP2 of the second hold circuit 205 due to the overflow of the signal charge from the valid pixel area VA to the HOB pixel area OBA1, the difference value d1 between the output signal HOP1 of the hold circuit 204 and the output signal HOP2 of the second hold circuit 205 obtained through the computation process of the subtraction circuit 215 increases.

It is noted that, when the HOB integration value itgHOB increases due to the overflow of the signal charge from the valid pixel area VA to the HOB pixel area OBA1, the difference value d1 output from the subtraction circuit 215 tends to increase depending on the sampling of the HOB pixel signal in the vicinity of the boundary between the HOB pixel area OBA1 and the valid pixel area VA.

The difference value d1 as an output signal CR of the subtraction circuit 215 is supplied to the comparator circuit (determination circuit) 216, and the difference value d1 is compared with the threshold value Vth.

When the difference value d1 is larger than the threshold value Vth, that is, when an overflow of the signal charge from the valid pixel area VA to the HOB pixel area OBA1 is detected, the output signal (hold timing signal) HT of the comparator circuit 216 is asserted, and the hold circuit 221 is activated. As a result, the HOB difference value dHOB2 from the fourth hold circuit (timing control circuit) 220A is held by the third hold circuit 221.

Therefore, when the output signal of the comparator circuit 216 is asserted, the HOB difference value dHOB2 generated from the output signal of the HOB pixel which is mostly unaffected by the overflow of the signal charge is received by the third hold circuit 221 that supplies a parameter to the computation circuit 213 for the OB clamping process.

The HOB difference value dHOB3 held by the hold circuit 221 is output to the computation circuit 213 as a HOB difference value dHOB3 for the OB clamping process.

Therefore, the OB clamping process for the valid image signal (e.g., the valid image signal subjected to the FBC process) RS is executed using the HOB difference value dHOB3 based on the HOB pixel signal which is mostly unaffected by the overflow of the signal charge from the valid pixel area VA to the HOB pixel area OBA1.

Therefore, in the solid-state imaging device according to the second embodiment, it is possible to improve an image quality of an image formed by the solid-state imaging device.

### (3) Third Embodiment

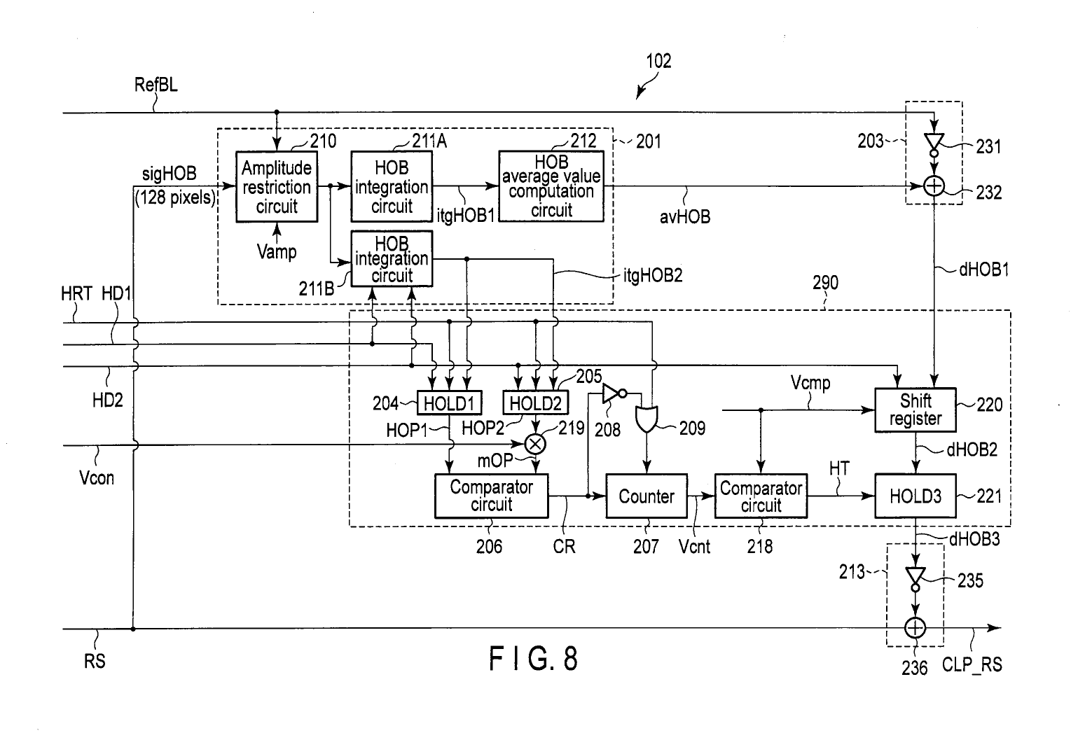

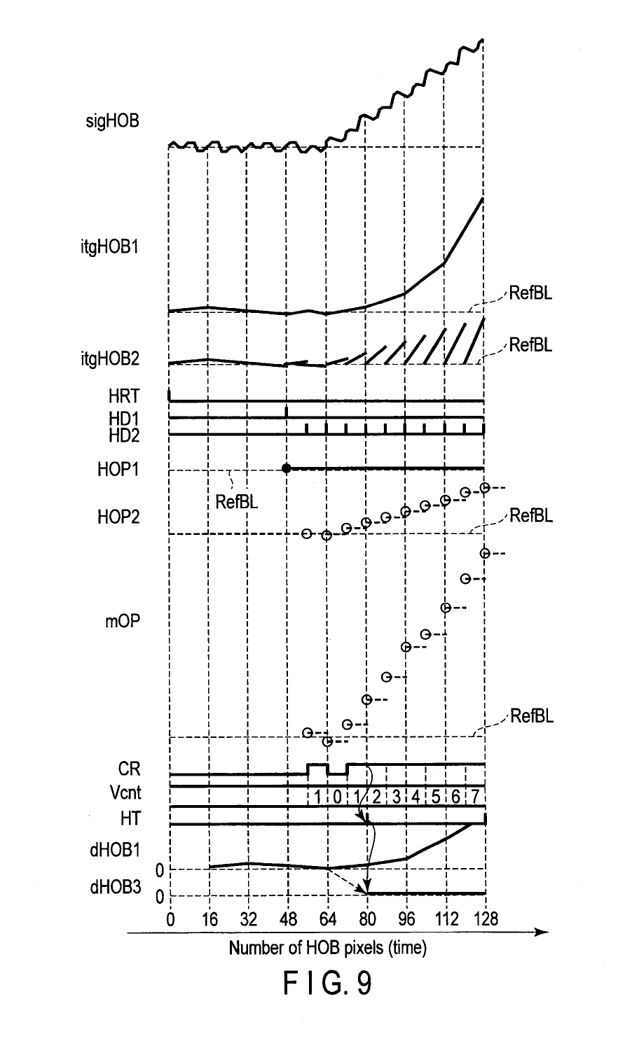

A solid-state imaging device according to a third embodiment will be described with reference to FIGS. 8 and 9.

In the third embodiment, the description will not be repeated for substantially the same configuration, function, and operation as those of the solid-state imaging devices according to the first and second embodiments.

The OB clamp circuit 102 of the solid-state imaging device according to the third embodiment is different from those of the first and second embodiments in that detection of an overflow of the signal charge is not executed for the light-blocking pixel which is mostly unaffected by the overflow of the signal charge in the area far from the boundary between the valid pixel area and the light-blocking pixel area (e.g., HOB pixel area).

In other words, in the OB clamp circuit 102 of the solid-state imaging device according to the third embodiment, detection of an overflow of the signal charge starts from the light-blocking pixel anticipated in advance to have a high possibility of the overflow of the signal charge from the valid pixel through a test process for the solid-state imaging device (or the image sensor).

FIG. 8 is a block diagram illustrating an exemplary internal configuration of the OB clamp circuit of the solid-state imaging device according to the third embodiment.

As illustrated in FIG. 8, a pair of HOB integration circuits 211A and 211B are provided in the OB clamp circuit 102.

The first HOB integration circuit 211A integrates the HOB pixel signal included in the image signal RS at every predetermined sampling period of a single horizontal line (row) (e.g., at every 16th pixel) to generate the HOB pixel signal integration value itgHOB1.

Similar to the first and second embodiments, the HOB average value computation circuit 212 computes the HOB average value avHOB from the HOB integration value itgHOB1 obtained from the first HOB integration circuit 211A. In addition, the obtained HOB average value avHOB and the black level reference value RefBL are computed by the computation circuit 203 to generate a HOB difference value dHOB1.

The second HOB integration circuit 211B integrates the HOB pixel signal sigHOB included in the image signal RS to generate a second HOB integration value itgHOB2. The second HOB integration circuit 211B is supplied with the first and second hold signals HD1 and HD2 and the hold reset signal HRT. The operation of the second HOB integration circuit 211B is controlled based on the hold signals HD1 and HD2 and the hold reset signal HRT. For example, if any one of the hold signals HD1 and HD2 and the hold reset signal HRT is asserted, the second HOB integration circuit 211B is reset.

It is noted that, when a pair of HOB integration circuits 211A and 211B are provided as in the OB clamp circuit of the third embodiment, for example, amplitude restriction within a range of d24 to d72 is performed for the HOB pixel signal before the HOB pixel signal is integrated by setting the black level reference value to d48 as described above.

The first and second hold circuits 204 and 205 are supplied with the HOB integration value itgHOB2 from the second HOB integration circuit 211B.

The first hold circuit (HOLD1) 204 is supplied with the hold reset signal HRT and the first hold signal HD1, and the operation of the hold circuit 204 is controlled by such signals HRT and HD1. The first hold circuit 204 is reset in response to the hold reset signal HRT at the head timing of the horizontal line of the pixel array 12 and holds the HOB integration value itgHOB2 at the timing that the hold signal HD1 is asserted.

For example, assuming that 128 pixels are provided in a single horizontal line of the HOB pixel area OBA1, the hold signal HD1 is asserted at the time of sampling of the output signal of the 48th HOB pixel, and the first hold circuit 204 holds the value of the HOB integration value itgHOB2 based on the asserted hold signal HD1 if there is a low possibility of the overflow of the signal charge in the area of the HOB pixels of the 1st to 48th pixels distant from the boundary between HOB pixel area OBA1 and the valid pixel area VA. The first hold circuit 204 continuously holds the value received when the first hold signal HD1 is asserted and supplies a constant HOB integration value (here, the HOB integration value up to the 48th HOB pixel) itgHOB2 to the comparator circuit 206 in the rear stage until the OB clamping process for a single horizontal line is completed.

The second hold circuit (HOLD2) 205 is supplied with the hold reset signal HRT and the second hold signal HD2, and the operation of the hold circuit 205 is controlled based on such signals HRT and HD2.

The second hold circuit 205 is reset in response to the hold reset signal HRT at the timing of the head of the horizontal line of the pixel array 12 and holds the HOB integration value itgHOB2 at the timing that the hold signal HD2 is asserted. For example, assuming that 128 pixels are provided in a single horizontal line of the HOB pixel area OBA1, the second hold signal HD2 is asserted at a pixel interval of 8 pixels subsequent to the 56th pixel. The second hold circuit 205 holds a value of the HOB integration value itgHOB2 based on the hold signal HD2 asserted at that pixel interval.

In this manner, the first and second hold circuits 204 and 205 are different in the timing of holding the HOB integration value itgHOB2 from the second HOB integration circuit 211B.

The output signal HOP2 of the second hold circuit 205 is output to the multiplication circuit 219. The multiplication circuit 219 is supplied with a certain coefficient Vcon. The multiplication circuit 219 multiplies the HOB signal integration value itgHOB2 by the coefficient and supplies the HOB integration value itgHOB2 multiplied by the coefficient to the comparator circuit 206. Here, the value of the coefficient Vcon is set to a ratio between a position (here, the 48th pixel) of the HOB pixel held by the hold signal HD1 and the pixel interval (here, a hold cycle of every 8th pixel) of the HOB pixel held by the hold signal HD2. For example, according to the third embodiment, the coefficient Vcon is set to “6” (=48/8).

The comparator circuit 206 compares the output signal HOP1 of the hold circuit 204 with the output signal mOP of the multiplication circuit 219 (output signal of the second hold circuit 205 multiplied by the coefficient Vcon).

When the output signal HOP1 of the hold circuit 204 is smaller than the output signal mOP of the multiplication circuit 219, the comparator circuit 206 asserts the output signal CR of the comparator circuit 206 based on the comparison result. Meanwhile, when the output signal HOP1 of the hold circuit 204 is equal to or larger than the output signal mOP of the multiplication circuit 219, the comparator circuit 206 de-asserts the output signal CR of the comparator circuit 206 based on the comparison result.

In this manner, the integration value held by the first hold circuit 204 (integration value not influenced by the overflow of the signal charge from the valid pixel) is used as one of reference values for detecting the overflow of the signal charge from the valid pixel to the light-blocking pixel (HOB pixel).

Similar to the first embodiment, the counter 207 executes a count operation in response to the output signal CR of the first comparator circuit 206. The second computation circuit (determination circuit) 210 compares the comparison value Vcmp and the count value Vcnt of the counter 207 and asserts or de-asserts the hold timing signal HT. When the count value Vcnt is equal to or larger than the comparison frequency Vcmp, the comparator circuit 218 asserts the hold timing signal HT.

The shift register 220 receives the HOB difference value dHOB1 from the computation circuit 203, for example, at the timing based on the hold signal HD2. The shift register 220 shifts a transmission timing of the received HOB difference value dHOB1 as specified by the comparison frequency Vcmp and outputs the result dHOB1 to third hold circuit 221 as the HOB difference value dHOB2.

The third hold circuit 221 receives the second HOB difference value dHOB2 supplied from the shift register 220 at the timing that the hold timing signal HT is asserted and outputs it to the computation circuit 213 as a third HOB difference value dHOB3.

When the hold timing signal HT is de-asserted, the third hold circuit 221 does not receive the value output from the shift register 220 at that timing. The value held by the third hold circuit 221 is output as the third HOB difference value dHOB3.

The operation of the solid-state imaging device according to the third embodiment will be described with reference to FIG. 9.

FIG. 9 is a schematic diagram illustrating the operation (signal processing) of the solid-state imaging device according to the third embodiment. In FIG. 9, the ordinate denotes a magnitude of each signal, and the abscissa denotes the number of light-blocking pixels of a single horizontal line and a sampling timing (time) of a signal.

For example, as illustrated in FIG. 9, if it is recognized, through a pre-test process for the image sensor (solid-state imaging device), that there is no influence of the leakage of the signal charge from the valid pixel area VA in a range from the first pixel to the 47th pixel of a single horizontal line of the HOB pixel area OBA1, detection of an overflow of the signal charge using the HOB integration value starts from the pixel subsequent to the 48th pixel in a single horizontal line of the HOB pixel area.

After the first and second hold circuits 204 and 205 are reset by the hold reset signal HRT, the signal level of the HOB pixel is integrated and averaged to generate the HOB difference value dHOB1.

Along with the integration process for the HOB pixel signal using the first HOB integration circuit 211A, the integration process for the HOB pixel signal using the second HOB integration circuit 211B is executed. However, the previous HOB signal integration value itgHOB2 is not held by the first and second hold circuits 204 and 205.

At the timing that the signal of the 48th HOB pixel is input, the first hold signal HD1 is asserted, and the HOB integration value itgHOB2 from the second HOB integration circuit 211B is held by the first hold circuit 204 in response to the first hold signal HD1 having an H-level.

As the hold signal HD1 is asserted, the second HOB integration circuit 211A is reset. In addition, in this case, since the hold signal HD2 is de-asserted, the output signal itgHOB2 of the second HOB integration circuit 211B is not held by the second hold circuit 205.

As a signal of the 48th HOB pixel is input, the first hold circuit 204 holds the HOB integration value. Then, the second hold signal HD2 is asserted at a pixel interval of 8 pixels, and the second hold circuit 205 receives the HOB integration value itgHOB2. Then, the second HOB integration value itgHOB2 is sequentially received by the second hold circuit 205 at the timing that the HOB signal is input at every 8th pixel (56th, 64th, 72nd, and so on).

It is noted that, since the second HOB integration circuit 211B is reset whenever the second hold signal HD2 is asserted, the integration value itgHOB2 received by the second hold circuit 205 is an integration value of the HOB pixel signals for 8 pixels.

The first hold circuit 204 receives the HOB integration value at the 48th HOB pixel signal input timing. Then, the first hold circuit 204 continuously holds the value received at the 48th HOB pixel signal input timing until the process for a single horizontal line is completed without receiving the HOB integration value itgHOB2 updated through the integration process until the processing sequence of the next horizontal line.

It is noted that, although the timing that the first hold signal HD1 is asserted is set as the timing of the 48th pixel, and the timing that the second hold signal HD2 is asserted is set as the timing of every 8th pixel according to the third embodiment, other values may also be set depending on a size of the pixel array or the HOB pixel area (number of pixels).

The output signal HOP2 of the second hold circuit 205 is supplied to the multiplication circuit 219, and the output signal HOP2 of the second hold circuit 205 is multiplied by a coefficient Vcon.

The output signal HOP1 of the first hold circuit 204 (integration value of the 1st to 48th HOB signals) and the output signal mOP of the multiplication circuit 219 are supplied to the comparator circuit 206. The magnitudes of such signals HOP1 and mOP are compared by the comparator circuit 206 when the integration value of the second hold circuit 205 is updated (at the timing of every 8th pixel).

When the output signal mOP of the multiplication circuit 219 is equal to or smaller than the output signal HOP1 of the first hold circuit (e.g., when the 64th HOB pixel is input), the output signal CR of the comparator circuit 206 is de-asserted, and count value Vcnt of the counter 207 is reset by the output signal of the OR-gate 209.

When the output signal mOP of the multiplication circuit 219 is larger than the output signal HOP1 of the first hold circuit 204 (e.g., when the 72th HOB pixel is input), the output signal CR of the comparator circuit 206 is asserted, and the H-level output signal CR is supplied to the counter 207. The count value Vcnt of the counter 207 is counted up. That is, since a state that the output signal mOP of the multiplication circuit 219 is larger than the output signal HOP1 of the hold circuit 204 is continuously maintained, the count value Vcnt increases.

Similar to the first embodiment, the count value Vcnt of the counter 207 is compared with a predetermined comparison value Vcmp using the comparator circuit 218.

If the count value Vcnt is equal to or larger than a value of the comparison value Vcmp (here, “2”), the hold timing signal HT is asserted.

Due to the asserted hold timing signal (e.g., an H-level signal) HT, the HOB difference value dHOB2 held by the shift register 220 is received by the third hold circuit 221. It is noted that the value received by the hold circuit 221 is not updated to the value held by the shift register 220 during the OB clamping process of a single horizontal line even when the count value Vcnt is smaller than the comparison value Vcmp after the value dHOB2 held by the shift register 220 is held by the third hold circuit 221.

The OB clamping process of the valid pixel signal is executed through a computation process for the image signal (e.g., the image signal subjected to an FBC process) RS using the output signal dHOB3 of the hold circuit 221.

As described above, similar to the first and second embodiments, the signal processing of the OB clamp circuit of the solid-state imaging device according to the third embodiment is executed using an output signal of the light-blocking pixel having no or little influence of the overflow of the signal charge from a valid pixel.

Therefore, in the solid-state imaging device according to the third embodiment, it is possible to improve an image quality of an image formed by the solid-state imaging device.

### (4) Fourth Embodiment

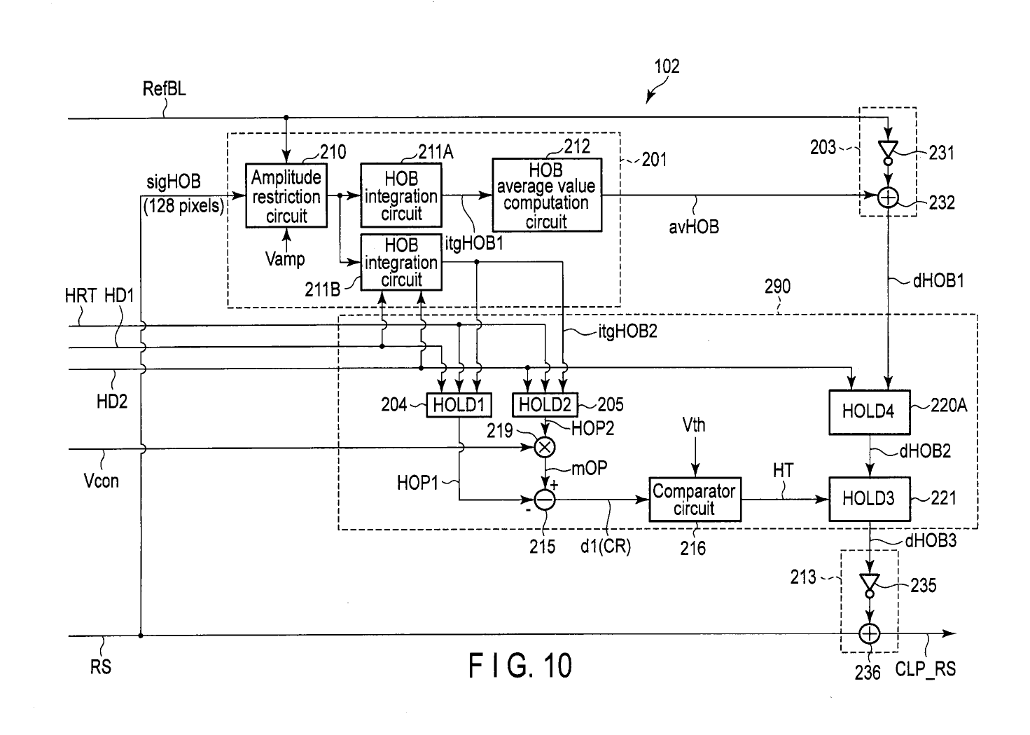

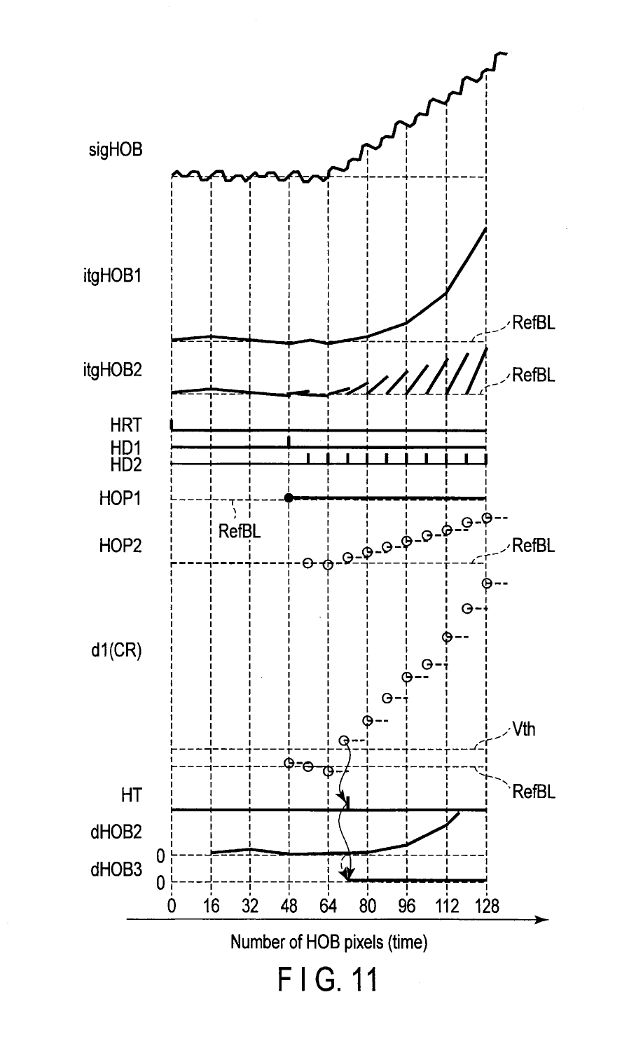

A solid-state imaging device according to a fourth embodiment will be described with reference to FIGS. 10 and 11.

According to the fourth embodiment, the description will not be repeated for substantially the same configuration, function, and operation as those of the solid-state imaging devices according to the first to third embodiments.

FIG. 10 is a block diagram illustrating a circuit configuration of the solid-state imaging device according to the fourth embodiment. In FIG. 10, an internal configuration of the OB clamp circuit of the solid-state imaging device is illustrated according to the fourth embodiment.

As illustrated in FIG. 10, the image sensor according to the fourth embodiment is different from that of the third embodiment in that a result of the computation process for the output signals of the first and second hold circuits 204 and 205 is compared with a predetermined threshold value to determine a value for performing the OB clamping process for the image signal.

For example, the processing for the output signals of the first and second hold circuits 204 and 205 is similar to the processing of the OB clamp circuit of the solid-state imaging device according to the second embodiment.

Substantially similar to the third embodiment, the HOB integration value itgHOB2 from the second HOB integration circuit 211B is supplied to each of the first and second hold circuits 204 and 205 at a predetermined timing. The HOB integration value itgHOB2 held by the second hold circuit 205 at every 8th pixel is multiplied by a coefficient Vcon using the multiplication circuit 219.

The subtraction circuit 215 executes a subtraction process for the value of the output signal HOP1 of the first hold circuit 204 and the value of the output signal mOP (=Vcon×itgHOB2) of the multiplication circuit 219. The subtraction circuit 215 outputs the result CR of the subtraction to the comparator circuit 216.

The comparator circuit (determination circuit) 216 compares the output signal (subtraction result) CR from the subtraction circuit 215 with a threshold value Vth. The comparator circuit 216 asserts the hold timing signal HT when the output signal CR from the subtraction circuit 215 is larger than the threshold value Vth.

FIG. 11 is a schematic diagram illustrating the operation (signal processing) of the solid-state imaging device according to the fourth embodiment. In FIG. 11, the ordinate denotes a magnitude of each signal, and the abscissa denotes the number of light-blocking pixels of a single horizontal line and a sampling timing (time).

As illustrated in FIG. 11, at the timing that the integration value itgHOB2 of the HOB pixel signals up to the 48th pixel is generated, the first hold signal HD1 is asserted, and the HOB integration value itgHOB2 is supplied to the first hold circuit 204. The first hold circuit 204 continuously holds the HOB integration value itgHOB2 of the HOB pixels up to 48th pixel until the OB clamping process of a single horizontal line is completed.

After the HOB pixel signal integration value itgHOB2 is held by the first hold circuit 204, the second hold signal HD2 is asserted at the timing of every 8th pixel from the 56th pixel, and the HOB pixel signal integration value itgHOB2 is supplied to the second hold circuit 205, so that the hold value is sequentially updated.

Similar to the second embodiment, the output signal HOP2 of the second hold circuit 205 is multiplied by a coefficient Vcon using the multiplication circuit 219, and the output signal mOP of the multiplication circuit 219 is supplied to the subtraction circuit 215 along with the output signal HOP1 of the first hold circuit 204.

The computation result d1(CR) of the subtraction between the output signal HOP1 of the first hold circuit 204 and the output signal mOP (HOP2×Vcon) of the multiplication circuit 219 is supplied to the comparator circuit 216, so that the computation result d1(CR) is compared with a threshold value Vth.

When the output signal (comparison result) d1(CR) of the subtraction circuit 215 is larger than the threshold value Vth, the hold timing signal HT is asserted. As a result, the HOB pixel signal dHOB2 of the hold circuit 220A at the timing that the hold timing signal HT is asserted is supplied to the third hold circuit 221.

The HOB difference value dHOB3 held by the third hold circuit 221 is used as a parameter for executing the OB clamping process for the image signal RS, and a processing for the image signal (e.g., valid image signal subjected to the FBC process) RS is executed.

As described above, similar to the first to third embodiments, in the solid-state imaging device according to the fourth embodiment and the operation thereof, a signal processing for the image signal is executed using a light-blocking pixel having no (or little) influence of the overflow of the signal charge from the valid pixel area to the light-blocking pixel area.

Therefore, in the solid-state imaging device according to the fourth embodiment, it is possible to improve an image quality of an image formed by the solid-state imaging device.

### (5) Modification

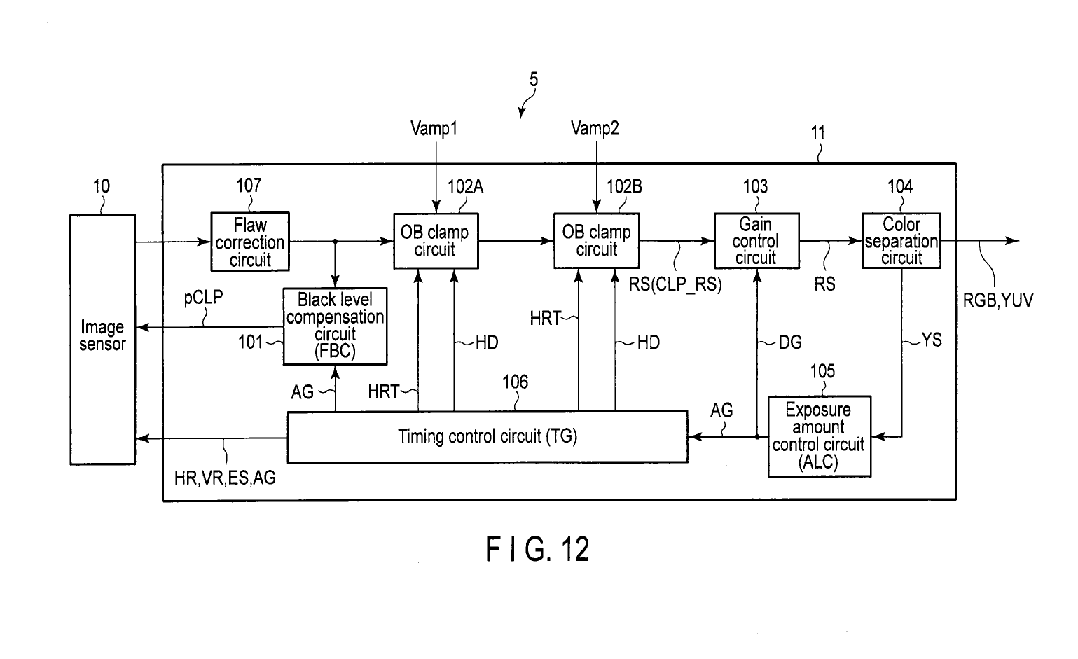

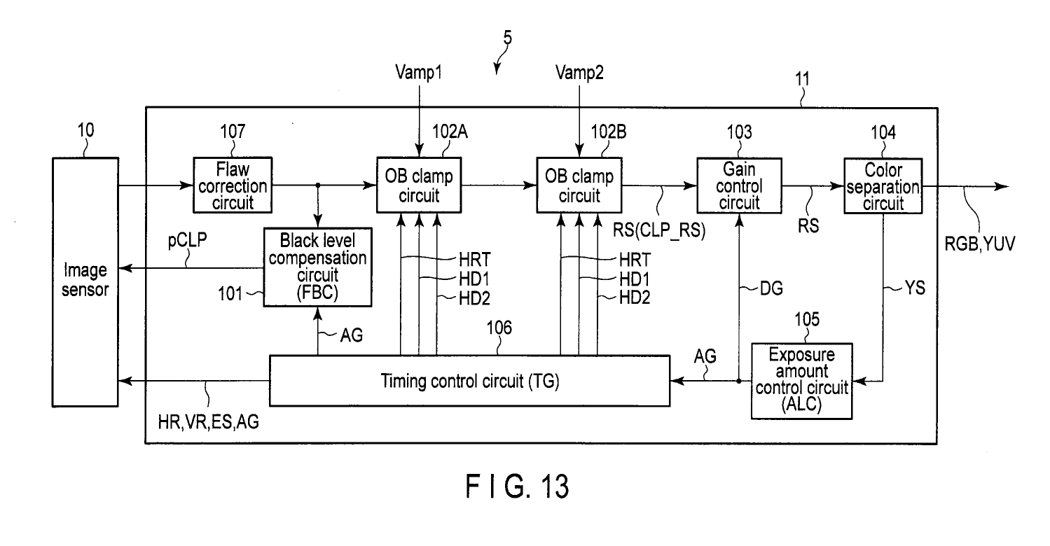

A modification of the solid-state imaging device (image sensor) according to an embodiment will be described with reference to FIGS. 12 and 13.

FIGS. 12 and 13 are block diagrams illustrating a configuration of the modification of the image sensor according to embodiments.

As illustrated in FIG. 12, the solid-state imaging device 5 having the OB clamp circuit described in the first or second embodiment may include a flaw correction circuit 107.

The flaw correction circuit 107 corrects a flaw of the image signal output from the image sensor 10 in the valid pixel area, the FBC area, and the HOB pixel area. In this manner, by performing the OB clamping process for a signal obtained by removing a noise caused by a flaw in the pixel array 12 using the flaw correction circuit 107, it is possible to improve an image quality of an image formed by the solid-state imaging device 5.

As illustrated in FIG. 12, a plurality of OB clamp circuits 102A and 102B according to the first or second embodiment described above may be provided in a single solid-state imaging device. In the example of FIG. 12, a pair of OB clamp circuits 102A and 102B are provided in the solid-state imaging device.

Each of the hold reset signal HRT and the hold signal HD is supplied to a pair of OB clamp circuits 102A and 102B.

A different amplitude restriction is set for a pair of OB clamp circuits 102A and 102B. For example, an amplitude value Vamp1 of the OB clamp circuit 102A of the front stage (image sensor side) out of a pair of OB clamp circuits of the solid-state imaging device is set to a relatively high value (wide restriction width), and the amplitude value Vamp2 of the OB clamp circuit 102B of the rear stage is set to a value (narrow restriction width) lower than the amplitude value Vamp2 of the OB clamp circuit 102A of the front stage.

Since a wide range amplitude restriction is used in the OB clamping process of the OB clamp circuit 102A of the front stage, the HOB difference value becomes large. As a result, even when the black level (HOB average value) significantly changes, it is possible to strongly catch the HOB difference value and the black level of the valid pixel.

Meanwhile, since a narrow range amplitude value Vamp2 is used in the clamping process of the OB clamp circuit 102B of the rear stage, it is possible to perform catching to a black level reference with high accuracy.

As illustrated in FIG. 13, a plurality of (here, “2”) OB clamp circuits 102A and 102B according to the third or fourth embodiments described above may be provided in the solid-state imaging device 5. The hold reset signal HRT and a pair of hold signals HD1 and HD2 are supplied to each of the OB clamp circuits 102A and 102B from the timing control circuit 106. In addition, amplitude values Vamp1 and Vamp2 having different levels are supplied to the OB clamp circuits 102A and 102B.

The flaw correction circuit 107 may be provided in the solid-state imaging device 5 having the OB clamp circuits 102A and 102B described in the third and fourth embodiments.

Using the solid-state imaging device 5 having the OB clamp circuit described in FIG. 13 according to the third or fourth embodiment, it is possible to obtain substantially the same effects as those of the solid-state imaging device of FIG. 12.

As described above, it is possible to improve an image quality using a modification of the solid-state imaging device according to an embodiment.

### (6) Application

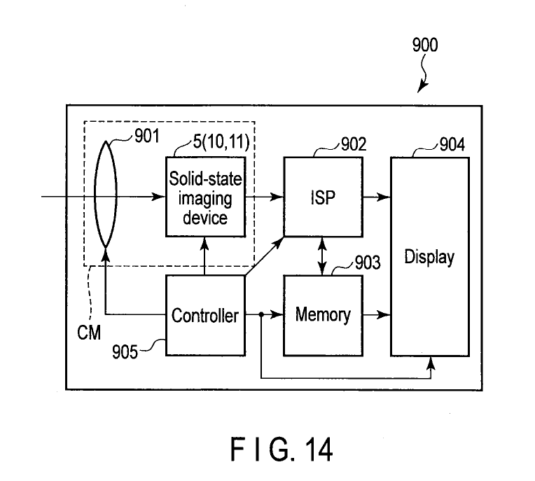

Application of the solid-state imaging device according to each embodiment will be described with reference to FIG. 14.

For example, the solid-state imaging device according to an embodiment is mounted on a digital camera as a module. In the following description, a module having the solid-state imaging device according to an embodiment will be referred to as a “camera module.”

As illustrated in FIG. 14, a camera module CM having the solid-state imaging device 5 according to an embodiment is mounted on a digital camera 900. The digital camera 900 includes an image processing circuit (ISP) 902, a memory 903, a display (904), and a controller 905.

The camera module CM of FIG. 14 has an optical lens unit (photographic imaging system) 901 in addition to the solid-state imaging device 5.

The optical lens unit 901 condenses incident light (light from a subject) onto the solid-state imaging device 5 according to an embodiment of the invention and focuses a subject image corresponding to the incident light on an image sensor 10 of the solid-state imaging device 5. The optical lens unit 901 has a plurality of lenses. By mechanically or electrically controlling each lens, an optical characteristic (e.g., a focal distance) of the optical lens unit 901 can be controlled.

The ISP 902 processes the image signal obtained through the imaging of the camera module CM. The data subjected to the signal processing in the ISP 902 is feedback-controlled in the camera module CM. A signal processing circuit 11 may be provided in the ISP 902.

The memory 903 stores a signal from the ISP 902. The memory 903 may store a signal or data received from the outside.

The signal from the ISP 902 or the signal from the memory 903 is displayed on a display (e.g., liquid crystal display) 904. The signal output from the ISP 902 and the memory 903 to the display 904 is image data (still image data or moving-picture data) corresponding to light from a subject, obtained by the solid-state imaging device 5. The controller 905 controls the operation of each part 5 and 901 to 904 of the digital camera 900.

The camera module CM may be applied to an electronic apparatus, for example, a camera-embedded mobile terminal, a camera-embedded personal computer, and a car camera in addition to the digital camera 900.

As described above, the solid-state imaging device 5 according to an embodiment may be applied to a camera module CM and a digital camera 900.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
an image sensor including a valid pixel area having a plurality of valid pixels and a light-blocking pixel area having a plurality of light-blocking pixels to generate an image signal from output signals of the valid pixels and the light-blocking pixels; and
at least one clamp circuit that detects an overflow of signal charge from the valid pixel area to the light-blocking pixel area and that executes a black level signal processing for the image signal using a parameter generated from signals of the light-blocking pixels,
wherein the clamp circuit detects the overflow of the signal charge using an integration value of the signals of the light-blocking pixels integrated in a direction from the light-blocking pixel area to the valid area, and sets the parameter generated from the output signals of the light-blocking pixels substantially not influenced by the overflow of the signal charge based on a result of the detection of the overflow of the signal charge.

2. The solid-state imaging device according to claim 1, wherein the clamp circuit includes
a first integration circuit that generates the integration value of the signals of the light-blocking pixels,
an average value computation circuit that generates an average value for the output signals of the light-blocking pixels from the integration value,
a first computation circuit that executes a computation process for the average value and a black level reference value,
a first hold circuit that holds the integration value at a first pixel interval,
a second hold circuit that holds an output signal of the first hold circuit at the first pixel interval,
a determination circuit that outputs an assertion signal when the overflow of the signal charge is detected based on the output signal of the first hold circuit and an output signal of the second hold circuit,
a timing control circuit that holds an output signal of the first computation circuit at the first pixel interval,
a third hold circuit that holds an output signal of the timing control circuit when the assertion signal is supplied, and
a processing circuit that executes a processing for the image signal by using an output signal of the third hold circuit as the parameter.

3. The solid-state imaging device according to claim 2, wherein the determination circuit includes
a first comparator circuit that compares the output signal of the first hold circuit and the output signal of the second hold circuit,
a counter that increments a count value based on an output signal of the first comparator circuit when the output signal of the first hold circuit is larger than the output signal of the second hold circuit,
a second comparator circuit that compares the count value and a determination value and that outputs the assertion signal when the count value is larger than the determination value.

4. The solid-state imaging device according to claim 3, wherein the timing control circuit is a shift register.

5. The solid-state imaging device according to claim 4, wherein the determination value is supplied to the shift register, and
the shift register outputs the output signal of the first computation circuit at a timing shifted depending on a value specified by the determination value to the third hold circuit.

6. The solid-state imaging device according to claim 2, wherein the determination circuit includes
a second computation circuit that performs a computation process for the output signal of the first hold circuit and the output signal of the second hold circuit,
a comparator circuit that compares an output signal of the second computation circuit and a determination value and that outputs the assertion signal when the output signal of the second computation circuit is larger than the determination value.

7. The solid-state imaging device according claim 6, wherein the second computation circuit executes a subtraction process using the output signal of the first hold circuit and the output signal of the second hold circuit.

8. The solid-state imaging device according claim 2, wherein the output signal of the second hold circuit is deviated by the first pixel interval from the output signal of the first hold circuit.

9. The solid-state imaging device according to claim 1, wherein the clamp circuit includes
first and second integration circuits that generate an integration value of output signals of the light-blocking pixels, respectively,
an average value computation circuit that generates an average value of the output signals of the light-blocking pixels from the integration value generated by the first integration circuit,
a first computation circuit that executes a computation process for the average value and a black level reference value,
a first hold circuit that holds the integration value of m light-blocking pixels generated by the second integration circuit,
a second hold circuit that holds the integration value of n light-blocking pixels generated by the second integration circuit at a pixel interval of the n pixels,
a second computation circuit that executes a computation process for an output signal of the second hold circuit using a first coefficient,
a determination circuit that outputs an assertion signal when the overflow of the signal charge is detected based on an output signal of the first hold circuit and an output signal of the second computation circuit,
a timing control circuit that holds an output signal of the first computation circuit at a pixel interval of the n pixels,
a third hold circuit that holds an output signal of the timing control circuit when the assertion signal is supplied, and
a processing circuit that executes a processing for the image signal by using an output signal of the third hold circuit as the parameter.

10. The solid-state imaging device according to claim 9, wherein the determination circuit includes
a first comparator circuit that compares the output signal of the first hold circuit and the output signal of the second computation circuit,
a counter that increments a count value based on an output signal of the first comparator circuit when the output signal of the second computation circuit is larger than the output signal of the first hold circuit,
a second comparator circuit that compares the count value and a determination value and that outputs the assertion signal when the count value is larger than the determination value.

11. The solid-state imaging device according to claim 10, wherein the timing control circuit is a shift register.

12. The solid-state imaging device according to claim 11, wherein the determination value is supplied to the shift register, and
the shift register outputs the output signal of the first computation circuit at a timing shifted depending on a value specified by the determination value to the third hold circuit.

13. The solid-state imaging device according to claim 9, wherein the determination circuit includes
a third computation circuit that executes a computation process for the output signal of the first hold circuit and the output signal of the second computation circuit,
a comparator circuit that compares an output signal of the third computation circuit and a determination value and that outputs the assertion signal when the output signal of the third computation circuit is larger than the determination value.

14. The solid-state imaging device according to claim 13, wherein the third computation circuit execute a subtraction process using the output signal of the first hold circuit and the output signal of the second computation circuit.

15. The solid-state imaging device according claim 9, wherein the second computation circuit multiplies the output signal of the second hold circuit by the first coefficient.

16. The solid-state imaging device according claim 9, wherein the first coefficient is a ratio of the m and the n.

17. The solid-state imaging device according claim 9, wherein the output signal of the first hold circuit is a constant value and the output signal of the second hold circuit is a value updated at the pixel interval of the n pixels from the integration value of m light-blocking pixels.

18. The solid-state imaging device according claim 1, further comprising:
a flaw correction circuit which is provided between the image sensor and the clamp circuit and which corrects a flaw of the image signal.

19. The solid-state imaging device according claim 1, wherein the at least one of the clamp circuit includes a first clamp circuit supplied with a first amplitude restriction and a second clamp circuit supplied with a second amplitude restriction,
wherein the first amplitude restriction is wider than the second amplitude restriction.

20. A solid-state imaging device comprising:
an image sensor including a valid pixel area having a plurality of valid pixels and a light-blocking pixel area having a plurality of light-blocking pixels to generate an image signal from output signals of the valid pixels and the light-blocking pixels; and
at least one clamp circuit that detects an overflow of signal charge from the valid pixel area to the light-blocking pixel area and that executes a black level signal processing for the image signal using a parameter generated from signals of the light-blocking pixels,
wherein the clamp circuit includes
a first integration circuit that generates an integration value of the signals of the light-blocking pixels integrated in a direction from the light-blocking pixel area to the valid area,
an average value computation circuit that generates an average value for the output signals of the light-blocking pixels from the integration value,
a first computation circuit that executes a computation process for the average value and a black level reference value,
a first hold circuit that holds the integration value at a first pixel interval,
a second hold circuit that holds an output signal of the first hold circuit at the first pixel interval,
a determination circuit that outputs an assertion signal when the overflow of the signal charge is detected based on the output signal of the first hold circuit and an output signal of the second hold circuit,
a timing control circuit that holds an output signal of the first computation circuit at the first pixel interval,
a third hold circuit that holds an output signal of the timing control circuit when the assertion signal is supplied, and
a processing circuit that executes a processing for the image signal by using an output signal of the third hold circuit as the parameter.
